(19) United States
(12) Patent Application Publication
(10) Pub. No.: US 2003/0198785 A1
(43) Pub. Date: Oct. 23, 2003

(54) Cover tape to be overlaid on a carrier tape for carrying parts therewith

(76) Inventors: Young Ha Ahn, Seoul (KR); Jin Sung Park, Seoul (KR); Seung Bae Ahn, Inchon (KR)

Correspondence Address: Kwangsoo Hyun, 931-9 Hwagok-1-Dong, Gangsuh-Gu, Seoul, KR

(21) Appl. No.: 10/418,066

(22) Filed: Apr. 18, 2003

(30) Foreign Application Priority Data
Apr. 23, 2002 (KR) 10-2002-0022304

(51) Int. Cl. B32B 7/12

(52) U.S. Cl. 428/192; 428/35.7; 428/354

(57) ABSTRACT

Disclosed is a group of carrier tapes in accordance with each of eleven versions of the present invention, each of which is to be overlaid on upper surface of the carrier tape wherein part-capturing means longitudinally disposed in at least one row is formed. First version of the cover tape comprises: a linear first base film; a linear first lining transversely overhung on one edge of the first base film and comprising a first film with a first sticky lining layered thereon; a linear second lining transversely overhung on the other edge and comprising a second film with a second sticky lining also layered thereon; whereby when the cover tape is overlaid and born down hard on the carrier tape, each of the first and second lining becomes in contact with upper surface of the carrier tape so that each of the parts captured in between the carrier tape and the cover tape can be carried over to a place intended therefor to be ready to be taken out as the cover tape is peeled off the carrier tape. Cover tapes in compliance with the second version of the present invention is each of the first-version cover tapes wherein the first and second sticky lining is replaced with the first and second non-sticky lining respectively so that the cover tape is overlaid and heat-staked on the carrier tape for capturing parts in between the cover tape and the carrier tape. Also disclosed are a wide variety of cover tapes in accordance with each of third through tenth and eleventh cover tapes, wherein each of the cover tapes basically comprises a base film; one selected from the first sticky lining, the first non-sticky lining, and the first combinational lining; one selected from the second sticky lining, the second non-sticky lining, and the second combinational lining; and at least one selected from the third sticky lining, the third non-sticky lining, and the third combinational lining, each of these wide spectrum of linings being disposed basically on lower surface of the base film.

### BACKGROUND OF THE INVENTION

1. Field of the Invention

The present invention relates to a cover tape to be overlaid on the carrier tape for use in the automated parts-implanting machine and carrying parts therewith. The process of automatically carrying and implanting various mechanical, electrical, electronic, and electromechanical parts inclusive of pharmaceutical tablets as on the printed circuit boards or on other varieties of plates and means for accepting such parts has become widely employed as a reliable and cost-effective mass-production means especially in the field of electronic-equipment manufacturing industries.

A cover tape is to be used together with a carrier tape wherein means for capturing aforementioned parts as in longitudinally disposed pockets is formed so that each of the parts to be carried thereby and implanted as on the printed circuit boards is successively fed into each of the pockets and then the cover tape with transversely-disposed longitudinal sticky linings formed as of adhesive materials and layered on one surface thereof is born down hard such that each of the parts is consecutively captured in each of the pockets disposed along the longitudinal direction of the carrier tape and then enclosed by the cover tape. Once the carrier tape assembly with parts loaded therein like a bandoleer is fed into the parts-implanting machine, each of the parts captured therein is carried by the machine by dragging the carrier tape assembly over to a place where such parts are to be implanted, then each of the parts is consecutively taken out of the pocket as by a pneumatically-operated suction cup or by a pair of jaws operated either mechanically or pneumatically, and then eventually implanted as on the printed circuit boards.

The base film for the cover tape used along with carrier tape for use in the parts-implanting machine is usually formed of a material comprising polyester, polyethylene, telephthalate, polypropylene, polystyrene, polyvynil chloride, and nylon inclusive of polycarbonate for pharmaceutical capsules or tablets, and is layered by a Gravier printing roller or a knife coater on one surface thereof with longitudinal sticky linings disposed transversely so that when it is overlaid on the carrier tape with said parts captured therein and born down hard on upper surface of the carrier tape, then the cover tape becomes in tight contact with a portion of the upper surface of the carrier tape along the longitudinal direction of the carrier tape so that each of the parts captured in between the carrier tape and the cover tape can be carried over to a place intended therefor to be ready to be taken out consecutively as the cover tape is peeled off the carrier tape with lower surface of the longitudinal sticky linings and the upper surface of the carrier tape separated from each other.

2. Description of the Conventional Art

As the longitudinal sticky linings layered on one surface of the base film of the cover tape along the longitudinal direction of the base film of the carrier tape is made in such a way that once several longitudinal sticky band linings doubling the breadth of each of the longitudinal sticky linings are printed on one surface of a raw film as by a Gravier printing roller with transverse disposition interval equaling the breadth of the base film of each of the carrier tapes, then slitting of the raw film is carried out with disc-type knives also disposed at the same lateral disposition interval to make several carrier tapes by slitting each of the band linings with each of the knives placed in alignment with the centerline of each of the band linings, it is extremely difficult to keep the exact alignment maintained between the centerline of each of the knives and that of each of the band linings so that the defect rate for the cover tapes becomes high in view of that fact that the magnitude of breadth of each of the band linings is relatively small as compared with that of the carrier tape. It is also required, in most cases, that a separate machine be required for each of the processes of printing and slitting due to the fact that each of the processes requires a certain travel distance for the raw film between them to accomodate sophisticated equipments and devices for each of the processes.

Under this circumstance, manufacturing cost for the cover tape becomes higher as it is needed to have two separate expensive machines to get the printing and slitting job done. In addition to that, there is no guarantee that breadth of each of the left and right longitudinal sticky lining of a cover tape be equal to each other. In order to take care of imbalance between the two sticky linings, some cover-tape manufacturers choose printing sticky material of overall area of one surface of a cover tape and additionally overlaying another thin film on it as disclosed in Korean utility design patent number 0,221,330, Seung Bae Ahn, and another Korean patent application serial number P1988-0009322, Ito Gasmi et. al, to have a non-sticky central zone that is supposed to be in contact with upper surface of each of the parts captured in each of the pockets disposed in the longitudinal direction of the carrier tape. This cover tape is, however, costly due to use of additional thin film on top of the cost for printing sticky material on overall area of one surface of the cover tape as compared with the conventional cover tape with two narrow longitudinal sticky linings layered on each of two marginal zones on one surface of the cover tape. Other conventional method to have the central zone non-sticky is to additionally overlay a solution that becomes non-sticky when dried up or cured after coating process.

3. Characteristic Features of the Present Invention

For these reasons set forth above, it is needed to have another method whereby negative features of the conventional method of coating various linings on one surface of the cover tape can be eliminated while dragging down the manufacturing cost therefor and exceeding or at least maintaining the quality of the conventional cover tape. In this regard, one characteristic feature of having sticky or non-sticky linings disposed on one surface of the cover tape is to prepare a sticky or non-sticky lining printed on a release film having the same breadth thereof as the sticky or non-sticky lining desired to be disposed on one surface of the base film of the cover tape and then laminate it wherever such linings are needed on the surface of the base film followed by taking the release film off the base film, thus leaving the sticky or non-sticky linings on the surface of the base film. The other unique feature of the cover tape in compliance with the present invention is at least one additional sticky or non-sticky lining transversely disposed on the central zone of the surface of the cover tape that is transversely confined by the two linings disposed on each side of the surface of the base film so that the cover tape can be overlaid on a carrier tape wherein at least two rows of means for capturing parts are disposed along the lateral direction of the carrier tape.

### SUMMARY OF THE INVENTION

It is the first object of the present invention to have a variety of cover tapes formed of a base film made of flexible solid material such as polyester whereon two sticky linings are laminated along a longitudinal direction of the cover tape so that when the cover tape is overlaid and born down hard on upper surface of the carrier tape with parts captured therein, each of a right portion of lower surface of the first sticky lining and a left portion of lower surface of the second sticky lining is in tight contact with a portion of the upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first sticky lining and the left portion of the lower surface of the second sticky lining, and the upper surface of the carrier tape separated from each other along the longitudinal direction of the carrier tape.

The first cover tape in compliance with the first version of the present invention is one to be overlaid on a carrier tape for carrying parts therewith. The first cover tape comprises: (a) a linear first base film made of flexible solid material, cross section of the first base film being of a transversely elongated square along a longitudinal direction of the first base film; (b) a linear first lining; and (c) a linear second lining. The first lining comprises (1) a first film formed of flexible solid material and having a transversely elongated square cross section thereof along a longitudinal direction of the first film, and (2) a first sticky lining formed of sticky material and layered on lower surface of the first film, the first lining being stuck to the first base film such that a left portion of lower surface of the first sticky lining is in tight contact with a right portion of upper surface of the first base film along the longitudinal direction of the first base film. The second lining comprises (1) a second film formed of flexible solid material and having a transversely elongated square cross section thereof along a longitudinal direction of the second film, and (2) a second sticky lining formed of sticky material and layered on lower surface of the second film, the second lining being stuck to the first base film such that a right portion of lower surface of the second sticky lining is in tight contact with a left portion of the upper surface of the first base film along the longitudinal direction of the first base film. With this cross-sectional embodiment of the cover tape, when the cover tape is overlaid and born down hard on upper surface of the carrier tape wherein parts are captured, each of a right portion of the lower surface of the first sticky lining and a left portion of the lower surface of the second sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape.

The second cover tape in compliance with the first version of the present invention is the first cover tape further comprising a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film.

The third cover tape in compliance with this version of the present invention is the first cover tape further comprising: at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

The fourth cover tape in compliance with this version of the present invention is the third cover tape further more comprising a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the lowermost second base film in the longitudinal direction of the first base film.

The fifth cover tape in compliance with this version of the present invention is each of the first, second, third, and fourth cover tapes further comprising: (a) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film; and (b) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second film in the longitudinal direction of the second film.

The sixth cover tape in compliance with this version of the present invention is the first cover tape further comprising: (a) at least one linear first upside film, each of the first upside films being formed of flexible solid material and having a transversely elongated square cross section thereof along a longitudinal direction of the first upside film, each of the first upside films being adhered to one another in such a way that lower surface of the first upside film disposed lowermost is in tight contact with upper surface of the first film in the longitudinal direction of the first film such that each of the first film and each of the first upside films stays together unless external force is applied thereto; and (b) at least one linear second upside film, each of the second upside films being formed of flexible solid material and having. a transversely elongated square cross section thereof along a longitudinal direction of the second upside film, each of the second upside films being adhered to one another in such a way that lower surface of the second upside film disposed lowermost is in tight contact with upper surface of the second film in the longitudinal direction of the second film such that each of the second film and each of the second upside films stays together unless external force is applied thereto.

The seventh cover tape in compliance with this version of the present invention is the sixth cover tape further comprising a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film.

The eighth cover tape in compliance with this version of the present invention is the sixth cover tape further more comprising: at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

The ninth cover tape in compliance with this version of the present invention is the eighth cover tape still further more comprising a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the second base film disposed lowermost in the longitudinal direction of the first base film.

The tenth cover tape in compliance with this version of the present invention is each of the sixth, seventh, eighth, and ninth cover tape further more comprising: (a) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film disposed uppermost in the longitudinal direction of the first film; and (b) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second upside film disposed uppermost in the longitudinal direction of the second film.

The eleventh cover tape in compliance with this version of the present invention is a cover tape to be overlaid on a carrier tape for carrying parts therewith. The eleventh cover tape comprises: (a) a linear first base film made of flexible solid material, cross section of the first base film being of a transversely elongated square along a longitudinal direction of the first base film; (b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in the longitudinal direction of the first base film; (c) a linear lower base-film coating made on lower surface of the first base film in the longitudinal direction of the first base film; (d) a linear first lining; (e) a first-film lining; (f) a linear second lining; and (g) a second-film lining. The lower base-film coating is made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent. The first lining comprises (1) a first film formed of flexible solid material and having a transversely elongated square cross section thereof along a longitudinal direction of the first film, and (2) a first sticky lining formed of sticky material and layered on lower surface of the first film, the first lining being stuck to the upper base-film coating such that a left portion of lower surface of the first sticky lining is in tight contact with a right portion of upper surface of the upper base-film coating along the longitudinal direction of the first base film. The first-film lining is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film. The second lining, on the other hand, comprises (1) a second film formed of flexible solid material and having a transversely elongated square cross section thereof along the longitudinal direction of the second film, and (2) a second sticky lining formed of sticky material and layered on lower surface of the second film, the second lining being stuck to the upper base-film coating such that a right portion of lower surface of the second sticky lining is in tight contact with a left portion of the upper surface of the upper base-film coating along the longitudinal direction of the first base film. Finally, the second-film lining is also formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on the upper surface of the second film in the longitudinal direction of the second film. With this cross-sectional embodiment of the cover tape, when the cover tape is overlaid and born down hard on upper surface of the carrier tape wherein parts are captured, each of a right portion of the lower surface of the first sticky lining and a left portion of the lower surface of the second sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first sticky lining and the left portion of the lower surface of the second sticky lining, and the upper surface of the carrier tape separated from each other along the longitudinal direction of the carrier tape.

It is the second object of the present invention to have a variety of cover tapes formed of a base film made of flexible solid material such as polyester whereon two non-sticky linings are laminated along a longitudinal direction of the cover tape so that when the cover tape is overlaid and heat-staked on upper surface of the carrier tape with parts captured therein, each of a right portion of lower surface of the first non-sticky lining and a left portion of lower surface of the second non-sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first non-sticky lining and the left portion of the lower surface of the second non-sticky lining, and the upper surface of the carrier tape separated from each other along the longitudinal direction of the carrier tape.

Each of the first through tenth and eleventh cover tape in compliance with a second version of the present invention is basically the same as each of the first through tenth and eleventh cover tapes in compliance with the first version of the present invention respectively, with the linear first sticky lower lining and the second sticky lower lining replaced with a linear first non-sticky lower lining and a linear second non-sticky lower lining, both being formed of non-sticky material such as hot-melt material.

The first cover tape in compliance with the second version of the present invention is a cover tape to be overlaid on a carrier tape for carrying parts therewith, the first cover tape comprising: (a) a linear first base film, cross section of the first base film being of a transversely elongated square along a longitudinal direction of the first base film; (b) a linear first lining; and (c) a linear second lining. The first lining comprises (1) a first film formed of flexible solid material and having a transversely elongated square cross section thereof along a longitudinal direction of the first film, and (2) a first non-sticky lining formed of non-sticky material and layered on lower surface of the first film, the first lining being heat-staked to the first base film such that a left portion of lower surface of the first non-sticky lining is in tight contact with a right portion of upper surface of the first base film along the longitudinal direction of the first base film. The second lining, on the other hand, comprises (1) a second film formed of flexible solid material and having a transversely elongated square cross section thereof along a longitudinal direction of the second film, and (2) a second non-sticky lining formed of non-sticky material and layered on lower surface of the second film, the second lining being heat-staked to the first base film such that a right portion of lower surface of the second non-sticky lining is in tight contact with a left portion of the upper surface of the first base film along the longitudinal direction of the first base film. With this cross-sectional embodiment of the cover tape, when the cover tape is overlaid and heat-staked on upper surface of the carrier tape wherein parts are captured, each of a right portion of the lower surface of the first non-sticky lining and a left portion of the lower surface of the second non-sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape.

The second cover tape in compliance with the second version of the present invention is the first cover tape further comprising a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film in the longitudinal direction of the first base film.

The third cover tape in compliance with the second version of the present invention is the first cover tape further comprising at least one linear second base film, each of the second base films being formed of a flexible material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

The fourth cover tape in compliance with the second version of the present invention is the third cover tape further more comprising a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the second base film disposed lowermost in the longitudinal direction of the first base film.

The fifth cover tape in compliance with the second version of the present invention is each of the first, second, third, and fourth cover tape further comprising (a) a first-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first film in the longitudinal direction of the first film; and (b) a second-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second film in the longitudinal direction of the second film.

The sixth cover tape in compliance with the second version of the present invention is the first cover tape further comprising: (a) at least one linear first upside film, each of the first upside films being formed of flexible solid material and having a transversely elongated square cross section thereof along a longitudinal direction of the first upside film, each of the first upside films being adhered to one another in such a way that lower surface of the first upside film disposed lowermost is in tight contact with upper surface of the first film in the longitudinal direction of the first film such that each of the first film and each of the first upside films stays together unless external force is applied thereto; and (b) at least one linear second upside film, each of the second upside films being formed of flexible solid material and having a transversely elongated square cross section thereof along a longitudinal direction of the second upside film, each of the second upside films being adhered to one another in such a way that lower surface of the second upside film disposed lowermost is in tight contact with upper surface of the second film in the longitudinal direction of the second film such that each of the second film and each of the second upside films stays together unless external force is applied thereto.

The seventh cover tape in compliance with the second version of the present invention is the sixth cover tape further more comprising a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film in the longitudinal direction of the first base film.

The eighth cover tape in compliance with the second version of the present invention is each of the sixth and seventh cover tape further more comprising at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

The ninth cover tape in compliance with the second version of the present invention is the eighth cover tape still further more comprising a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the second base film disposed lowermost in the longitudinal direction of the first base film.

The tenth cover tape in compliance with the second version of the present invention is each of the sixth, seventh, eighth, and ninth cover tape further more comprising: (a) a first-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first upside film disposed uppermost in the longitudinal direction of the first base film; and (b) a second-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second upside film disposed uppermost in the longitudinal direction of the first base film.

The eleventh cover tape in compliance with the second version of the present invention is a cover tape to be overlaid on a carrier tape for carrying parts therewith, the cover tape comprising: (a) a linear first base film made of flexible solid material, cross section of the first base film being of a transversely elongated square along a longitudinal direction of the first base film; (b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in the longitudinal direction of the first base film; (c) a linear lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film; (d) a linear first lining; (e) a first-film lining; (f) a linear second lining; and (g) a second-film lining. The first lining comprises (1) a first film formed of flexible solid material and having a transversely elongated square cross section thereof along a longitudinal direction of the first film, and (2) a first non-sticky lining formed of non-sticky material and layered on lower surface of the first film, the first lining being stuck to the upper base-film coating such that a left portion of lower surface of the first non-sticky lining is in tight contact with a right portion of upper surface of the upper base-film coating along the longitudinal direction of the first base film. The first-film lining is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film. The second lining comprises (1) a second film formed of flexible solid material and having a transversely elongated square cross section thereof along the longitudinal direction of the second film, and (2) a second non-sticky lining formed of non-sticky material and layered on lower surface of the second film, the second lining being stuck to the upper base-film coating such that a right portion of lower surface of the second non-sticky lining is in tight contact with a left portion of the upper surface of the upper base-film coating along the longitudinal direction of the first base film. The second-film lining is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on the upper surface of the second film in the longitudinal direction of the second film. When the cover tape with this cross section is overlaid and heat-staked on upper surface of the carrier tape wherein parts are captured, each of a right portion of the lower surface of the first non-sticky lining and a left portion of the lower surface of the second non-sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first non-sticky lining and the left portion of the lower surface of the second non-sticky lining, and the upper surface of the carrier tape separated from each other along the longitudinal direction of the carrier tape.

It is the third object of the present invention to have a variety of cover tape formed of a base film made of flexible solid material such as polyester whereon at least two sandwich-type sticky linings are laminated along the longitudinal direction of the cover tape so that when the cover tape is overlaid and born down hard on upper surface of the carrier tape with parts captured therein, lower surface of each of the first and second sticky lining and optionally of each of at least one third sticky lining is in tight contact with a portion of upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with the lower surface of each of these linings and the upper surface of the carrier tape separated from each other along the longitudinal direction of the carrier tape.

The first cover tape in compliance with the third version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear first lining; and (c) a linear second lining. The first lining comprises (1) a first film formed of flexible solid material and having a transversely elongated square cross section thereof along a longitudinal direction of the first film, (2) a first sticky lower lining formed of sticky material and layered on lower surface of the first film, and (3) a first sticky upper lining formed of sticky material and layered on upper surface of the first film, upper surface of the first sticky upper lining being stuck to a right portion of lower surface of the first base film along the longitudinal direction of the first film. The second lining, on the other hand, comprises (1) a second film formed of flexible solid material and having a transversely elongated square cross section thereof along a longitudinal direction of the second film, (2) a second sticky lower lining formed of sticky material and layered on lower surface of the second film, and (3) a second sticky upper lining formed of sticky material and layered on upper surface of the second film, upper surface of the second sticky upper lining being stuck to a left portion of the lower surface of the first base film along the longitudinal direction of the second film. With this cross-sectional embodiment of the cover tape, when the cover tape is overlaid and born down hard on upper surface of the carrier tape wherein parts are captured, lower surface of each of the first sticky lining and second sticky lower lining is in tight contact with a portion of upper surface of the carrier tape along a longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

The second cover tape in compliance with the third version of the present invention is the first cover tape further comprising at least one linear third lining, each of the third linings comprising (1) a third film formed of flexible solid material and having a transversely elongated square cross section thereof along a longitudinal direction of the third film, (2) a third sticky lower lining formed of sticky material and layered on lower surface of the third film, and (3) a third sticky upper lining formed of sticky material and layered on upper surface of the third film, upper surface of the third sticky upper lining being stuck to a portion of a middle portion of the lower surface of the first base film along the longitudinal direction of the first base film, the middle portion being transversely confined by the left and right portion of the lower surface of the first base film along the longitudinal direction of the first base film; whereby lower surface of each of the third sticky lower linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

The third cover tape in compliance with the third version of the present invention is each of the fist and second cover tape further comprising: a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

The third cover tape in compliance with the third version of the present invention is each of the first and second cover tape further comprising: at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

The fourth cover tape in compliance with the third version of the present invention is the fourth cover tape further more comprising: a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

It is the fourth object of the present invention to have a variety of cover tape formed of a base film made of flexible solid material such as polyester with at least two sandwich-type sticky linings laminated on a base-film lower lining layered on the lower surface of the base film along the longitudinal direction of the cover tape so that when the cover tape is overlaid and born down hard on upper surface of the carrier tape with parts captured therein, lower surface of each of the first and second sticky lining and selectively each of at least one third sticky lining is in tight contact with a portion of upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these sticky linings and the upper surface of the carrier tape separated from each other along the longitudinal direction of the carrier tape.

The first cover tape in compliance with the fourth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film; (c) a linear first lining; and (d) a linear second lining. The first lining comprises (1) a first film formed of flexible solid material and having a transversely elongated square cross section thereof along a longitudinal direction of the first film, (2) a first sticky lower lining formed of sticky material and layered on lower surface of the first film, and (3) a first sticky upper lining formed of sticky material and layered on upper surface of the first film, upper surface of the first sticky upper lining being stuck to a right portion of lower surface of the lower base-film coating along the longitudinal direction of the first base film. The second lining, on the other hand, comprises (1) a second film formed of flexible solid material and having a transversely elongated square cross section thereof along a longitudinal direction of the second film, (2) a second sticky lower lining formed of sticky material and layered on lower surface of the second film, and (3) a second sticky upper lining formed of sticky material and layered on upper surface of the second film, upper surface of the second sticky upper lining being stuck to a left portion of the lower surface of the lower base-film coating along the longitudinal direction of the first base film. So, when the cover tape having this cross-sectional embodiment is overlaid and born down hard on upper surface of the carrier tape wherein parts are captured, lower surface of each of the first and second sticky lower lining is in tight contact with a portion of upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lower lining, and the upper surface of the carrier tape separated from each other along the longitudinal direction of the carrier tape.

The second cover tape in compliance with the fourth version of the present invention is the first cover tape further comprising at least one linear third lining, each of the third linings comprising (1) a third film formed of flexible solid material and having a transversely elongated square cross section thereof along a longitudinal direction of the third film, (2) a third sticky lower lining formed of sticky material and layered on upper surface of the third film, and (3) a third sticky upper lining formed of sticky material and layered on lower surface of the third film, upper surface of the third sticky upper lining being stuck to a portion of a middle portion of the lower surface of the lower base-film coating along the longitudinal direction of the first base film, the middle portion being transversely confined by the right portion and the left portion of the lower surface of the lower base-film coating along the longitudinal direction of the first base film, whereby lower surface of each of the third sticky lower linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

The third cover tape in compliance with the fourth version of the present invention is each of the first and second cover tape further comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

The fourth cover tape in compliance with the fourth version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the lower base-film coating in the longitudinal direction of the first base film such that each of the first base film and each of the second base films stays together unless external force is applied thereto.

The fifth cover tape in compliance with the fourth version of the present invention is the fourth cover tape further more comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

It is the fifth object of the present invention to have a variety of cover tape formed of a base film made of flexible solid material such as polyester with at least two sticky linings laminated on a lower base-film coating made on the lower surface of the base film along the longitudinal direction of the cover tape so that when the cover tape is overlaid and born down hard on upper surface of the carrier tape with parts captured therein, lower surface of each of the first sticky lining and second sticky lining and selectively of each of at least one third sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these sticky linings and the upper surface of the carrier tape separated from each other along the longitudinal direction of the carrier tape.

The first cover tape in compliance with the fifth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film; (c) a linear first sticky lining; and (d) a linear second sticky lining. The first sticky lining is formed of sticky material and layered on a right portion of lower surface of the lower base-film coating along the longitudinal direction of the first base film, while the second sticky lining is formed of sticky material and layered on a left portion of the lower surface of the lower base-film coating along the longitudinal direction of the first base film, the right portion and the left portion of the lower surface of the lower base-film coating transversely confining a middle portion of the lower surface of the lower base-film coating along the longitudinal direction of the base film. When the cover tape with this cross-sectional embodiment is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

The second cover tape in compliance with the fifth version of the present invention is the first cover tape further comprising at least one linear third sticky lining, each of the third sticky linings being formed of sticky material and layered on a portion of the middle portion of the lower surface of the lower base-film coating along the longitudinal direction of the first base film; whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

The third cover tape in compliance with the fifth version of the present invention is each of the first and second cover tape further comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

The fourth cover tape in compliance with the fifth version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

The fifth cover tape in compliance with the fifth version of the present invention is the fourth cover tape further more comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

It is the sixth object of the present invention to have a variety of cover tape formed of a base film made of flexible solid material such as polyester with at least two non-sticky linings formed of non-sticky material inclusive of the Hot-Melt material and laminated on a lower base-film coating made on the lower surface of the base film along the longitudinal direction of the cover tape so that when the cover tape is overlaid and heat-staked on upper surface of the carrier tape with parts captured therein, lower surface of each of the first and second non-sticky lining and optionally of each of third non-sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these non-sticky linings and the upper surface of the carrier tape separated from each other along the longitudinal direction of the carrier tape.

The first cover tape in compliance with the sixth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film; (c) a linear first non-sticky lining; and (d) a linear second non-sticky lining. The first non-sticky lining is formed of non-sticky material and layered on a right portion of lower surface of the lower base-film coating along the longitudinal direction of the first base film, while the second non-sticky lining is formed of non-sticky material and layered on a left portion of the lower surface of the lower base-film coating along the longitudinal direction of the first base film, the right portion and the left portion of the lower surface of the lower base-film coating transversely confining a middle portion of the lower surface of the lower base-film coating along the longitudinal direction of the base film. When the cover tape with this cross-sectional embodiment is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

The second cover tape in compliance with the sixth version of the present invention is the first cover tape further comprising at least one linear third non-sticky lining, each of the third non-sticky linings being formed of non-sticky material and layered on a portion of the middle portion of the lower surface of the lower base-film coating along the longitudinal direction of the first base film; whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

The third cover tape in compliance with the sixth version of the present invention is each of the first and second cover tape further comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in a longitudinal direction of the first base film.

The fourth cover tape in compliance with the sixth version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

The fifth cover tape in compliance with the sixth version of the present invention is the fourth cover tape further more comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second base film disposed uppermost in the longitudinal direction of the first base film.

It is the seventh object of the present invention to have a variety of cover tape formed of a base film made of flexible solid material such as polyester whereon at least two combinational linings, each of which consists of a non-sticky lining and a sticky lining, are laminated along the longitudinal direction of the cover tape so that when the cover tape is overlaid and born down hard on upper surface of the carrier tape with parts captured therein, lower surface of each of the combinational linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these combinational linings and the upper surface of the carrier tape separated from each other along the longitudinal direction of the carrier tape.

The first cover tape in compliance with the seventh version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a first combinational lining; and (c) a second combinational lining. The first combinational lining comprises (1) a first non-sticky lining formed of non-sticky material, and (2) a first sticky lining formed of sticky material and layered on lower surface of the first non-sticky lining along a longitudinal direction of the first non-sticky lining, the first non-sticky lining being layered on a right portion of lower surface of the first base film along the longitudinal direction of the first base film. The second combinational lining comprises (1) a second non-sticky lining formed of non-sticky material, and (2) a second sticky lining formed of sticky material and layered on lower surface of the second non-sticky lining along a longitudinal direction of the second non-sticky lining, the second non-sticky lining being layered on a left portion of lower surface of the first base film along the longitudinal direction of the first base film. When the cover tape having this cross-sectional embodiment is overlaid and born down hard on upper surface of the carrier tape wherein parts are captured, lower surface of each of the first combinational lining and the second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining and the second combinational lining, and the upper surface of the carrier tape separated from each other along the longitudinal direction of the carrier tape.

The second cover tape in compliance with the seventh version of the present invention is the first cover tape further comprising at least one third combinational lining, each of the third combinational linings comprising (1) a third non-sticky lining formed of non-sticky material, and (2) a third sticky lining formed of sticky material and layered on lower surface of the third non-sticky lining along the longitudinal direction of the third non-sticky lining, the third non-sticky lining being layered on a portion of a middle portion of the lower surface of the first base film along the longitudinal direction of the first base film, the middle portion being transversely confined by the left portion and the right portion of the lower surface of the first base film; whereby lower surface of each of the third combinational linings is additionally in tight contact with a portion of the upper surface of the carrier tape so that when the cover tape is peeled off the carrier tape, the lower surface of each of the first combinational lining, the second combinational lining, and each of the third combinational linings, and the upper surface of the carrier tape is separated from each other along the longitudinal direction of the carrier tape.

The third cover tape in compliance with the seventh version of the present invention is each of the first and second cover tape further comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

The fourth cover tape in compliance with the seventh version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

The fifth cover tape in compliance with the seventh version of the present invention is the fourth cover tape further more comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

It is the eighth object of the present invention to have a variety of cover tape formed of a base film made of flexible solid material such as polyester with at least two combinational linings, each of which consists of a non-sticky lining and a sticky lining, laminated on a lower base-film coating made on the lower surface of the base film along the longitudinal direction of the cover tape so that when the cover tape is overlaid and born down hard on upper surface of the carrier tape with parts captured therein, lower surface of each of the combinational linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these combinational linings and the upper surface of the carrier tape separated from each other along the longitudinal direction of the carrier tape.

The first cover tape in compliance with the eighth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film; (c) a first combinational lining; and (d) a second combinational lining. The first combinational lining comprises (1) a first non-sticky lining formed of non-sticky material, and (2) a first sticky lining formed of sticky material and layered on lower surface of the first non-sticky lining along a longitudinal direction of the first non-sticky lining, the first non-sticky lining being layered on a right portion of lower surface of the lower base-film coating along the longitudinal direction of the first base film. The second combinational lining, on the other hand, comprises (1) a second non-sticky lining formed of non-sticky material, and (2) a second sticky lining formed of sticky material and layered on lower surface of the second non-sticky lining along a longitudinal direction of the second non-sticky lining, the second non-sticky lining being layered on left portion of lower surface of the lower base-film coating along the longitudinal direction of the first base film. When the cover tape having this cross-sectional embodiment is overlaid and born down hard on upper surface of the carrier tape wherein parts are captured, lower surface of each of the first and second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining and the second combinational lining, and the upper surface of the carrier tape separated from each other along the longitudinal direction of the carrier tape.

The second cover tape in compliance with the eighth version of the present invention is the first cover tape further comprising at least one third combinational lining, each of the third combinational linings comprising (1) a third non-sticky lining formed of non-sticky material, and (2) a third sticky lining formed of sticky material and layered on lower surface of the third non-sticky lining along a longitudinal direction of the third non-sticky lining, the third non-sticky lining being layered on a portion of a middle portion of the lower surface of the lower base-film coating along the longitudinal direction of the first base film, the middle portion being transversely confined by the left portion and the right portion of the lower surface of the lower base-film coating; whereby lower surface of each of the third combinational linings is additionally in tight contact with a portion of the upper surface of the carrier tape so that when the cover tape is peeled off the carrier tape, the lower surface of each of the first combinational lining, the second combinational lining, and each of the third combinational linings, and the upper surface of the carrier tape is separated from each other along the longitudinal direction of the carrier tape.

The third cover tape in compliance with the eighth version of the present invention is each of the first and second cover tape further comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

The fourth cover tape in compliance with the eighth version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

The fifth cover tape in compliance with the eighth version of the present invention is the fourth cover tape further more comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

It is the ninth object of the present invention to have a variety of cover tape formed of a base film made of flexible solid material such as polyester whereon at least two non-sticky linings are laminated along a longitudinal direction of the cover tape so that when the cover tape is overlaid and heat-staked on upper surface of the carrier tape with parts captured therein, lower surface of each of these non-sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these non-sticky linings and the upper surface of the carrier tape separated from each other along the longitudinal direction of the carrier tape.

The first cover tape in compliance with the ninth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear first non-sticky lining; and (c) a linear second non-sticky lining. The first non-sticky lining is formed of non-sticky material and layered on a right portion of lower surface of the first base film along the longitudinal direction of the first base film, while the second non-sticky lining is formed of non-sticky material and layered on a left portion of lower surface of the first base film along the longitudinal direction of the first base film. When the cover tape having this cross-sectional embodiment is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

The second cover tape in compliance with the ninth version of the present invention is the first cover tape further comprising at least one linear third non-sticky lining, each of the third non-sticky linings being formed of non-sticky material and layered on a portion of a middle portion of the lower surface of the first base film along the longitudinal direction of the first base film, the middle portion being transversely confined by the right portion and left portion of the lower surface of the first base film; whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

The third cover tape in compliance with the ninth version of the present invention is each of the first and second cover tape further comprising at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

It is the tenth object of the present invention to have a variety of cover tape formed of a base film made of flexible solid material such as polyester with at least two non-sticky linings laminated on a lower base-film coating made on the lower surface of the base film along a longitudinal direction of the cover tape so that when the cover tape is overlaid and heat-staked on upper surface of the carrier tape with parts captured therein, lower surface of each of these non-sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of these non-sticky linings and the upper surface of the carrier tape separated from each other along the longitudinal direction of the carrier tape.

The first cover tape in compliance with the tenth version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film; (c) a linear first non-sticky lining; (d) a linear second non-sticky lining; and (e) a linear upper base-film coating made on upper surface of the first base film in the longitudinal direction of the first base film. The first non-sticky lining is formed of non-sticky material and layered on a right portion of lower surface of the lower base-film coating along the longitudinal direction of the first base film, while the second non-sticky lining is formed of non-sticky material and layered on a left portion of the lower surface of the lower base-film coating along the longitudinal direction, of the first base film. The upper base-film coating made of one selected from a group consists of (1) anti-static material formed of at least one selected from a group consisting of carbon, metal, metal oxide, positive ion, negative ion, non-ion, and conductor inclusive of organic polymer, and (2) coloring agent. When the cover tape with this cross section is overlaid and heat-staked on upper surface of the carrier tape wherein parts are captured, lower surface of each of the first non-sticky lining and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

The second cover tape in compliance with the tenth version of the present invention is the first cover tape further comprising at least one linear third non-sticky lining formed of non-sticky material and layered on a middle portion of the lower surface of the lower base-film coating along the longitudinal direction of the first base film, the middle portion being transversely confined by the right portion and the left portion of the lower surface of the lower base-film coating along the longitudinal direction of the first base film; whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

The third cover tape in compliance with the tenth version of the present invention is a cover tape to be overlaid on a carrier tape for carrying parts therewith, the third cover tape comprising: (a) a linear first base film made of flexible solid material, cross section of the first base film being of a transversely elongated square along a longitudinal direction of the first base film; (b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film; (d) a linear first non-sticky lining; (e) a linear second non-sticky lining; and (f) a linear upper base-film coating made on upper surface of the second base film in the longitudinal direction of the first base film. The first non-sticky lining is formed of non-sticky material and layered on a right portion of lower surface of the lower base-film coating along the longitudinal direction of the first base film, while the second non-sticky lining is formed of non-sticky material and layered on a left portion of the lower surface of the lower base-film coating along the longitudinal direction of the first base film. Finally, the upper base-film coating is made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second base film in the longitudinal direction of the first base film. So, when the cover tape with this cross section is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

The fourth cover tape in compliance with the tenth version of the present invention is the third cover tape further comprising at least one linear third non-sticky lining formed of non-sticky material and layered on a middle portion of the lower surface of the lower base-film coating along the longitudinal direction of the first base film, the middle portion being transversely confined by the right portion and the left portion of the lower surface of the lower base-film coating along the longitudinal direction of the first base film; whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

Finally, it is the eleventh object of the present invention to have a variety of cover tape formed of a base film made of flexible solid material such as polyester whereon at least two sticky linings are laminated along a longitudinal direction of the cover tape so that when the cover tape is overlaid and born down hard on upper surface of the carrier tape with parts captured therein, lower surface of each of these sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with the lower surface of each of these sticky linings and the upper surface of the carrier tape separated from each other along the longitudinal direction of the carrier tape.

The first cover tape in compliance with the eleventh version of the present invention is one to be overlaid on a carrier tape for carrying parts therewith, the first cover tape comprising: (a) a linear first base film made of flexible solid material, cross section of the first base film being of a transversely elongated square along a longitudinal direction of the first base film; (b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film; (c) a linear first sticky lining; and (d) a linear second sticky lining. The first sticky lining is formed of sticky material and layered on a right portion of lower surface of the first base film along the longitudinal direction of the first base film, while the second sticky lining is formed of sticky material and layered on a left portion of lower surface of the first base film along the longitudinal direction of the first base film. When the cover tape having this cross section is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

The second cover tape in compliance with the final version of the present invention is the first cover tape further comprising at least one linear third sticky lining, each of the third sticky linings being formed of sticky material and layered on a portion of a middle portion of the lower surface of the first base film along the longitudinal direction of the first base film, the middle portion being transversely confined by the right portion and the left portion of the lower surface of the first base film; whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

The third cover tape in compliance with the final version of the present invention is one to be overlaid on a carrier tape for carrying parts therewith, the third cover tape comprising: (a) a linear first base film made of flexible solid material, cross section of the first base film being of a transversely elongated square along a longitudinal direction of the first base film; (b) a linear first sticky lining formed of sticky material and layered on a right portion of lower surface of the first base film along the longitudinal direction of the first base film; (b) a linear first sticky lining; (c) a linear second sticky lining; and (d) at least one linear third sticky lining. The first sticky lining is formed of sticky material and layered on a right portion of lower surface of the first base film along the longitudinal direction of the first base film, while the second sticky lining is formed of sticky material and layered on a left portion of the lower surface of the first base film along the longitudinal direction of the first base film. Each of the third sticky linings is formed of sticky material and layered on a portion of a middle portion of the lower surface of the first base film along the longitudinal direction of the first base film, the middle portion being transversely confined by the right portion and the left portion of the lower surface of the first base film. When the cover tape with this cross section is overlaid and born down hard on upper surface of the carrier tape wherein parts are captured, lower surface of each of the first sticky lining, the second sticky lining, and each of the third sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining, the second sticky lining, and each of the third sticky linings, and the upper surface of the carrier tape separated from each other along the longitudinal direction of the carrier tape.

The fourth cover tape in compliance with the final version of the present invention is one to be overlaid on a carrier tape for carrying parts therewith, the fourth cover tape comprising: (b) at least one linear second base film, each of the second base films being formed of flexible solid material, cross section of each of the second base films being of a transversely elongated square along the longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto; (c) a linear first sticky lining; and (d) a linear second sticky lining. The first sticky lining is formed of sticky material and layered on a right portion of lower surface of the first base film along the longitudinal direction of the first base film, while the second sticky lining is formed of sticky material and layered on a left portion of the lower surface of the first base film along the longitudinal direction of the first base film. When the cover tape with this cross section is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

The fifth cover tape in compliance with the final version of the present invention is the fourth cover tape further comprising at least one linear third sticky lining, each of the third sticky linings being formed of sticky material and layered on a portion of a middle portion of the lower surface of the first base film along the longitudinal direction of the first base film, the middle portion being transversely confined by the right portion and the left portion of the lower surface of the first base film; whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

The final sixth cover tape in compliance with the final eleventh version of the present invention is each of the fourth and fifth cover tape comprising a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

### BRIEF DESCRIPTION OF THE DRAWINGS

FIG. 1 is a 3-dimensional view of a carrier tape assembly wherein an embodiment to the cover tape whose cross section is disclosed in FIG. 4 in accordance with each of first and second versions of the present invention;

FIGS. 2 through 17 and 18 are cross-sectional embodiment of a variety of the cover tapes in accordance with each of the first and second versions of the present invention;

FIG. 19 is a 3-dimensional view of a carrier tape assembly wherein an embodiment to the cover tape whose cross section is disclosed in FIG. 21 in accordance with third version of the present invention;

FIGS. 20 through 26 and 27 show cross-sectional embodiment of a variety of the cover tapes in accordance with the third version of the present invention;

FIGS. 28 through 34 and 35 disclose cross-sectional embodiment of a variety of the cover tapes in accordance with fourth version of the present invention;

FIGS. 36 through 42 and 43 reveal cross-sectional embodiment of a variety of the cover tapes in accordance with fifth version of the present invention;

FIGS. 44 through 50 and 51 show cross-sectional embodiment of a variety of the cover tapes in accordance with sixth version of the present invention;

FIGS. 52 through 58 and 59 disclose cross-sectional embodiment of a variety of the cover tapes in accordance with seventh version of the present invention;

FIGS. 60 through 66 and 67 reveal cross-sectional embodiment of a variety of the cover tapes in accordance with eighth version of the present invention;

FIGS. 68, 69, 70, and 71 show cross-sectional embodiment of a variety of the cover tapes in accordance with ninth version of the present invention;

FIGS. 72, 73, 74, and 75 illustrate cross-sectional embodiment of a variety of the cover tapes in accordance with tenth version of the present invention; and

FIGS. 76 through 81 and 82 cover cross-sectional embodiment of a variety of the cover tapes in accordance with eleventh version of the present invention.

### DETAILED DESCRIPTION OF THE INVENTION

As set forth in the background of the present invention, one unique feature of the cover tape in accordance with the present invention as opposed to conventional means for adhering cover tapes onto upper surface of the corresponding carrier tapes is that each of the sticky linings or non-sticky linings is laminated on upper surface of the cover tape after prior preparation of such linings printed on a separate release film having the same breadth as said linings desired to be disposed on the surface of the base film of the cover tape, and the separate release film is then taken off the lining now laminated on the upper surface of the cover tape while the conventional methods of coating such linings is also applicable to some of the cover tapes disclosed in this specification. Cross-sectional embodiment of each of 80 cover tapes in accordance with eleven versions of the present invention is described as follows.

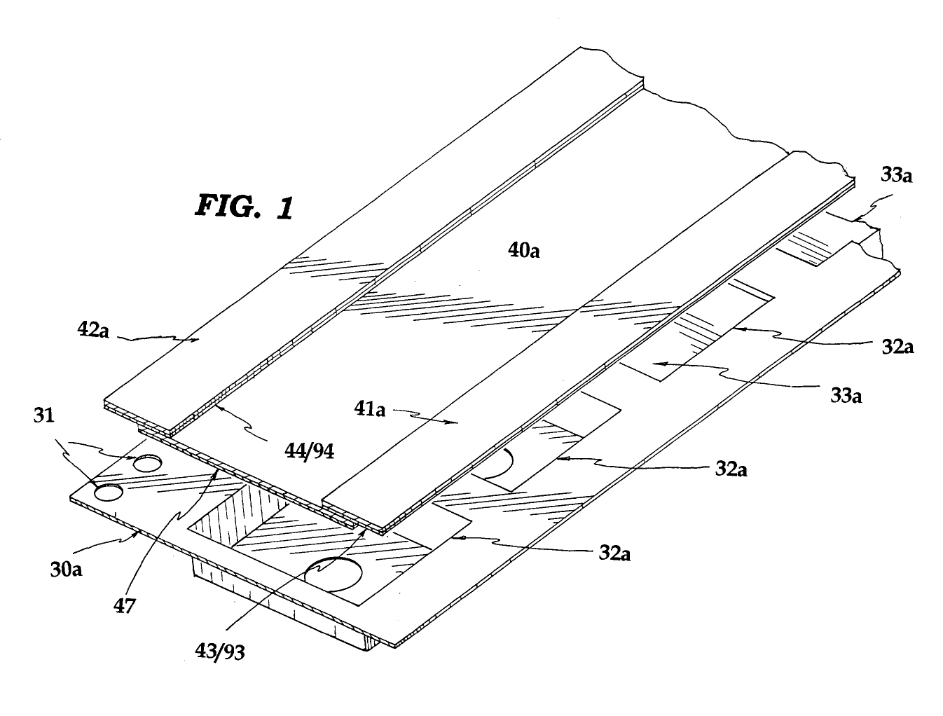

FIG. 1 is a 3-dimensional view of a carrier tape assembly wherein an embodiment to the cover tape whose cross section is more clearly disclosed in FIG. 4 in compliance with each of the first and second version of the present invention. The carrier tape is provided with longitudinally disposed dragger circular holes 31 on one edge of the upper surface of the carrier tape 30a for longitudinal feeding of the carrier tape wherein square pockets 32a are disposed with parts 33a enclosed therein.

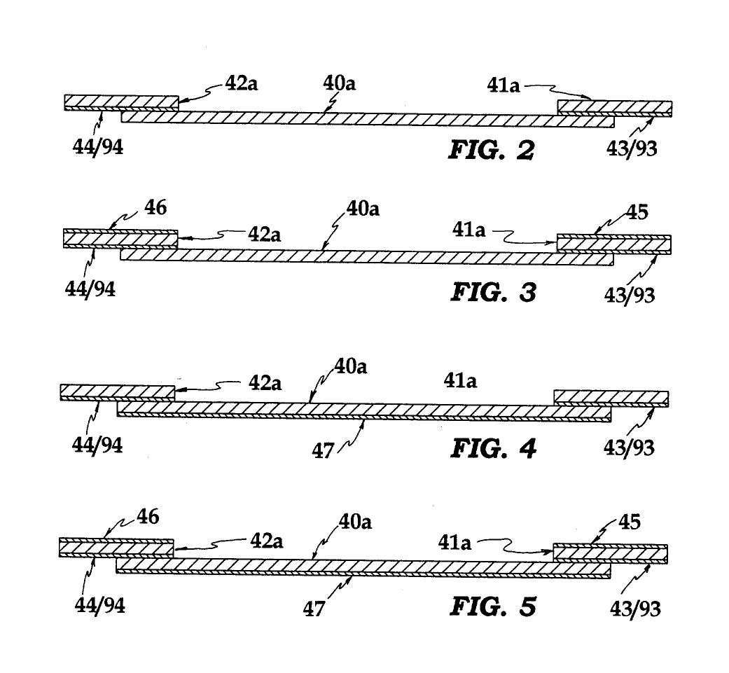

FIGS. 2 through 17 and 18 show cross-sectional embodiment of each of the cover tapes in accordance with each of the first and second version of the present invention. Cross-sectional embodiment of FIG. 2 is for a cover tape to be overlaid on a carrier tape for carrying parts enclosed in part-capturing means formed in a carrier tape and disposed in a longitudinal direction of the carrier tape. The cover tape for which cross-sectional embodiment shown in FIG. 2 in accordance with the first version consists of a linear first base film 40a formed of flexible solid material, cross section of the first base film 40a being of a transversely elongated square along a longitudinal direction of the first base film 40a; a linear first lining 41a,43; and a linear second lining 42a,44. The first lining consists of (1) a first film 41a formed of flexible solid material and having a transversely elongated square cross section thereof along a longitudinal direction of the first film 40a, and (2) a first sticky lining 43 formed of sticky material and layered on lower surface of the first film 41a. The first lining is then stuck to the first base film 40a such that a left portion of lower surface of the first sticky lining 43 is in tight contact with a right portion of upper surface of the first base film 40a along the longitudinal direction of the first base film 40a. The second lining consists of (1) a second film 42a also formed of the same material as the first film 41a and having a transversely elongated square cross section thereof along a longitudinal direction of the second film 42a, and (2) a second sticky lining 44 also formed of the same sticky material as that for the first sticky lining 43 and layered on lower surface of the second film 42a, the second lining 44 being stuck to the first base film 40a such that a right portion of lower surface of the second sticky lining 44 is in tight contact with a left portion of the upper surface of the first base film 40a along the longitudinal direction of the first base film 40a. When the cover tape is overlaid and born down hard on upper surface of the carrier tape wherein parts are captured, each of a right portion of the lower surface of the first sticky lining 43 and a left portion of the lower surface of the second sticky lining 44 becomes in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of first sticky lining 43 and the left portion of the lower surface of the second sticky lining 44, and the upper surface of the carrier tape separated from each other along the longitudinal direction of the carrier tape.

FIG. 3 discloses a cross-sectional embodiment to the cover tape of FIG. 2, further consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer; (2) coloring agents; and (3) release agent, and layered on upper surface of the first film 41a; and (b) a second-film lining 46 formed of the same material as that for the first-film lining 45, and layered on upper surface of the second film 42a.

FIG. 4 discloses a cross-sectional embodiment of the cover tape of FIG. 2, further consisting of a lower base-film coating 47 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film 40a. The reason for coating said lower base-film lining on the lower surface of the first base film 40a is that the parts enclosed in the part-capturing means disposed in the carrier tape with which the current cover tape is supposed to be overlaid may be sensitive to electric charges transmitted from the first cover tape 40a, for example.

FIG. 5 is a cross-sectional embodiment to the cover tape of FIG. 4, further more consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film 41a; and (b) a second-film lining 46 also formed of the same material as that for the first-film lining 45, and layered on upper surface of the second film 42a.

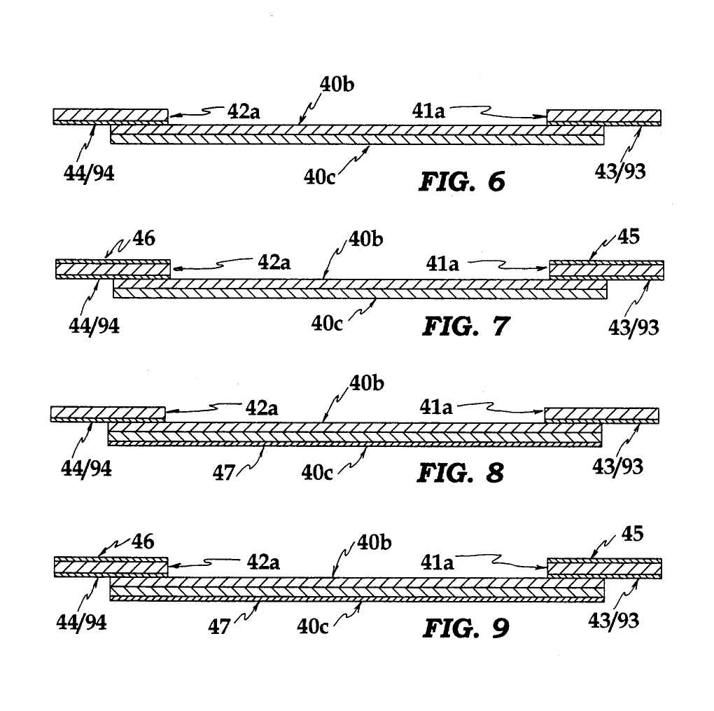

FIG. 6 discloses a cross-sectional embodiment of the cover tape of FIG. 2, further consisting of: (a) a linear second base film 40c formed of flexible solid material and having a transversely elongated square cross section thereof along a longitudinal direction of a second base film 40c, and adhered to the first base film 40b in such a way that upper surface of the second base film 40c is in tight contact with lower surface of the first base film 40b in the longitudinal direction of the cover tape such that each of the first base film 40b and the second base film 40c stays together unless external force is applied thereto. It is to be noted that at least one said second base film 40c may be adhered to the lower surface of the first base film 40b, which is within the scope of the claims of the present invention.

FIG. 7 discloses a cross-sectional embodiment of the cover tape of FIG. 6, further more consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film 41a; and (b) a second-film lining 46 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second film 42a.

FIG. 8 discloses a cross section of the cover tape of FIG. 6 further more consisting of a lower base-film coating 47 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the second base film 40c.

FIG. 9 discloses a cross section of the cover tape of FIG. 8 still further more consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film 41a; and (b) a second-film lining 46 still here formed of the same material as the first-film lining 45, and layered on upper surface of the second film 42a.

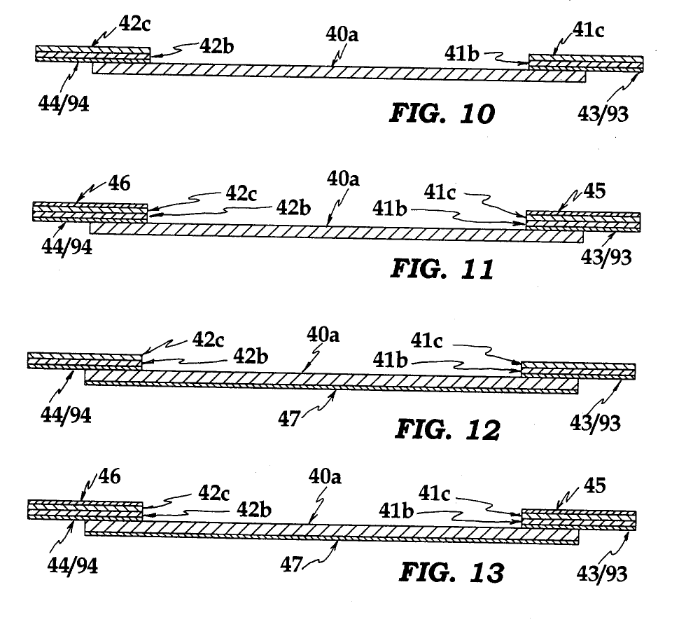

FIG. 10 discloses a cross section of the cover tape of FIG. 2 further consisting of a linear first upside film 41c and a linear second upside film 42c. The linear first upside film 41c is formed of flexible solid material and has a transversely elongated square cross section thereof along a longitudinal direction of the first upside film 41c, the first upside film 41c being adhered to the first film 41b in such a way that lower surface of the first upside film 41c is in tight contact with upper surface of the first film 41b in the longitudinal direction of the first base film 40a such that each of the first film 41b and the first upside film 41c stays together unless external force is applied thereto. The linear second upside film 42c is also formed of flexible solid material and has transversely elongated square cross section thereof along a longitudinal direction of the second upside film 42c, the second upside film 41c being adhered to second film 42b in such a way that lower surface of the second upside film 42c is in tight contact with upper surface of the second film 42b in the longitudinal direction of the first base film 40a. It is also to be noted that at least one said first upside film 41c and second upside film 42c may be adhered to upper surface of the first film 41b and the second film 42b respectively.

FIG. 11 reveals a cross-sectional embodiment of the cover tape of FIG. 10, further more consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film 41c; and (b) a second-film lining 46 formed of the same material as that for the first-film lining 45, and layered on upper surface of the second upside film 42c.

FIG. 12 discloses an embodiment of the cover tape of FIG. 10, further more consisting of a lower base-film coating 47 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film 40a.

FIG. 13 reveals a cross-sectional embodiment of the cover tape of FIG. 12, still further more consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film 41c; and (b) a second-film lining 46 formed of the same material as that for the first-film lining 45, and layered on upper surface of the second upside film 42c. The release agent layered on the upper surface of each of the first upside film 41c and the second upside film 42c as shown in FIGS. 11 and 13 may prevent separation of the first sticky lining 43 and the upper surface of the first base film 40a from happening when the cover tape is continuously released as from a feed roll for the cover tape for overlaying on the upper surface of the carrier tape.

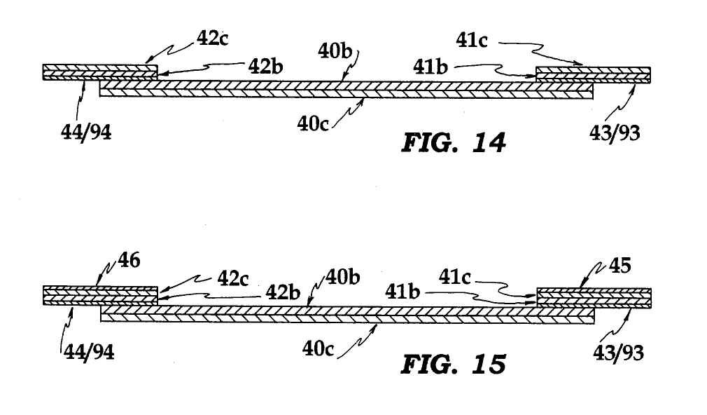

FIG. 14 discloses an embodiment of the cover tape of FIG. 10 further more consisting of a linear second base film 40c. The second base film 40c is formed of flexible solid material and has a transversely elongated square cross section thereof along a longitudinal direction of the second base film 40c. The second base film 40c is adhered to the first base film 40b in such a way that upper surface of the second base film 40c is in tight contact with lower surface of the first base film 40b in the longitudinal direction of the cover tape such that each of the first base film 40b and the second base film 40c stays together unless external force is applied thereto. It is to be noted that at least one said linear second base film 40c may be adhered to the lower surface of the first base film 40b.

FIG. 15 discloses a cross-sectional embodiment of the cover tape of FIG. 14 still further more consisting of: (a) a first-film lining 45; and (b) a second-film lining 46, each of which is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film 41c and the second upside film 42c respectively.

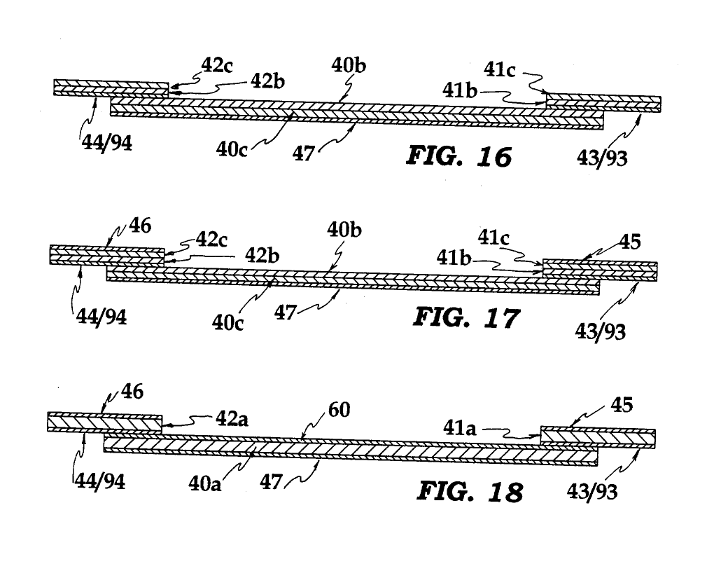

FIG. 16 is a cross-sectional embodiment of the cover tape of FIG. 14, still further more consisting of a lower base-film coating 47 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the second base film 40c.

FIG. 17 discloses a cross-sectional embodiment of the cover tape of FIG. 16, still further consisting of: (a) a first-film lining 45 formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film 41c; and (b) a second-film lining 46 formed of the same material as that for the first-film lining 45, and layered on upper surface of the second upside film 42c.

FIG. 18 discloses a cross-sectional embodiment of a cover tape to be overlaid on a carrier tape wherein part-capturing means typically in single row is longitudinally disposed. The cover tape consists of: (a) a linear first base film 40a formed of flexible solid material, cross section of the first base film 40a being of a transversely elongated square along a longitudinal direction of the first base film 40a; (b) a linear upper base-film coating 60; (c) a linear lower base-film coating 47; (d) a linear first lining 41a,43; (e) a first-film lining 45; (f) a linear second lining 42a,44; and (g) a second-film lining 46. The upper base-film coating 60 is formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on the upper surface of the first base film 40a in the longitudinal direction of the first base film 40a. The lower base-film coating 47 is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film 40a in the longitudinal direction of the first base film 40a. The first lining consists of (1) a first film 41a formed of flexible solid material and has a transversely elongated square cross section thereof along a longitudinal direction of the first film 41a, and (2) a first sticky lining 43 formed of sticky material and layered on lower surface of the first film 41a, the first lining being stuck to the upper base-film coating such that a left portion of lower surface of the first sticky lining 43 is in tight contact with a right portion of upper surface of the upper base-film coating 47 along the longitudinal direction of the first base film 40a, while the first-film lining 45 is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film 41a in the longitudinal direction of the first film 41a. The second lining consists of (1) a second film 42a formed of flexible solid material and having a transversely elongated square cross section thereof along the longitudinal direction of the second film 42a, and (2) a second sticky lining 44 formed of sticky material and layered on lower surface of the second film 42a, the second lining being stuck to the upper base-film coating 62a such that a right portion of lower surface of the second sticky lining 44 is in tight contact with a left portion of the upper surface of the upper base-film coating 62a along the longitudinal direction of the first base film 40a, while the second-film lining 46 is formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on the upper surface of the second film 42a in the longitudinal direction of the second film 42a. When the cover tape is overlaid and born down hard on upper surface of the carrier tape wherein parts are captured, each of a right portion of the lower surface of the first sticky lining 43 and a left portion of the lower surface of the second sticky lining 44 is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first sticky lining 43 and the left portion of the lower surface of the second sticky lining 44, and the upper surface of the carrier tape separated from each other along the longitudinal direction of the carrier tape.

Each of the cross-sectional embodiments of the cover tapes as disclosed in FIGS. 2 through 16 and 17 constitutes cross-sectional embodiments of cover tapes in accordance with the second version of cover tapes of the present invention, wherein each of the linear first sticky lining 43 and the linear second sticky lining 44 is replaced with a linear first non-sticky lining 93 and a linear second non-sticky lining 94 respectively. Cross-sectional embodiment of the first cover tape in the second version of the present invention that is to be overlaid on a carrier tape for carrying parts therewith is then again shown in FIG. 2. The cover tape consists of: (a) a linear first base film 40a, cross section of the first base film 40a being of a transversely elongated square along a longitudinal direction of the first base film 40a; (b) a linear first lining consisting of (1) a first film 41a formed of flexible solid material and having a transversely elongated square cross section thereof along a longitudinal direction of the first film 41a, and (2) a first non-sticky lining 93 formed of non-sticky material and layered on lower surface of the first film 41a, the first lining being heat-staked to the first base film 40a such that a left portion of lower surface of the first non-sticky lining 93 is in tight contact with a right portion of upper surface of the first base film 40a along the longitudinal direction of the first base film 40a; and (c) a linear second lining comprising: (1) a second film 42a formed of flexible solid material and having a transversely elongated square cross section thereof along a longitudinal direction of the second film 42a, and (2) a second non-sticky lining 94 formed of non-sticky material and layered on lower surface of the second film 42a, the second lining being heat-staked to the first base film 40a such that a right portion of lower surface of the second non-sticky lining 93 is in tight contact with a left portion of the upper surface of the first base film 40a along the longitudinal direction of the first base film 40a; whereby when the cover tape is overlaid and heat-staked on upper surface of the carrier tape wherein parts are captured, each of a right portion of the lower surface of the first non-sticky lining 93 and a left portion of the lower surface of the second non-sticky lining 94 is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first non-sticky lower lining 93 and the left portion of the lower surface of the second non-sticky lower lining 94 and the upper surface of the carrier tape separated from each other along the longitudinal direction of the carrier tape.

Cross-sectional embodiment of each of FIGS. 3 through 16, and 17 for the second version of the cover tapes of the present invention is basically the same as that for the first version of the cover tapes of the present invention with the first sticky lining 43 and second sticky lining 44 replaced with the first non-sticky lining 93 and second non-sticky lining 94 respectively, so that dumb repetition of the detailed description for the cover tapes in compliance with the second version of the present invention is not worth while and is omitted accordingly.

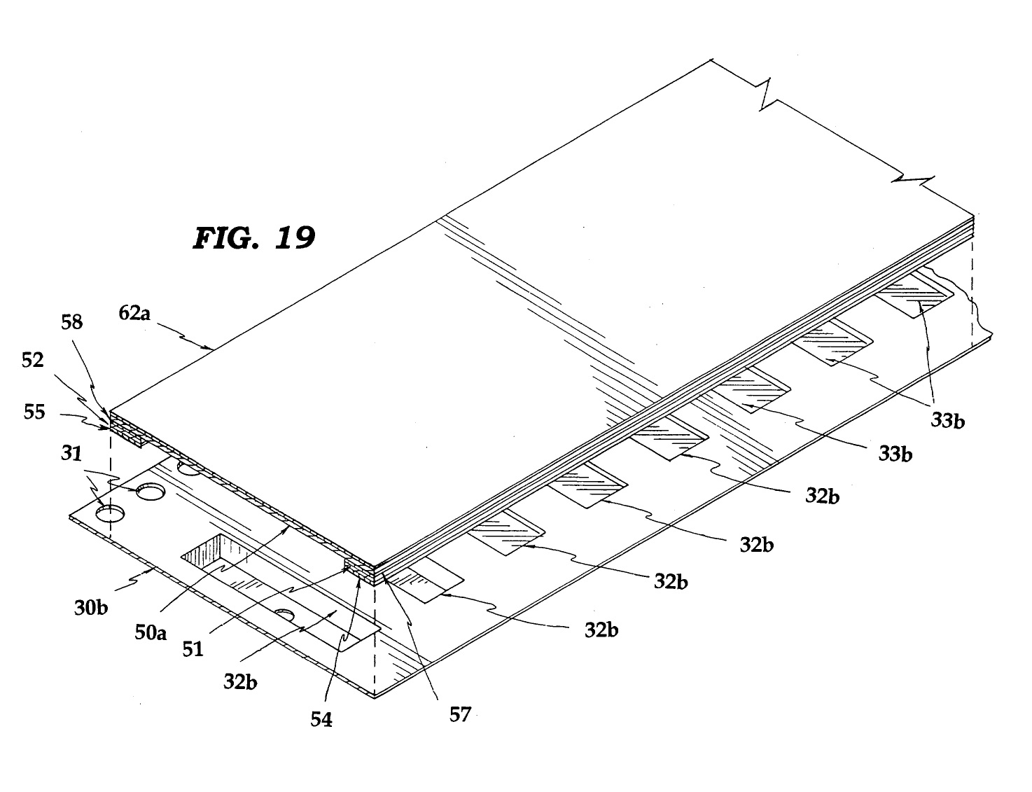

FIG. 19 is a 3-dimensional view of a carrier tape assembly wherein an embodiment to the cover tape whose plan view of the cross section is disclosed in FIG. 21, in compliance with the third version of the present invention. The carrier tape is also provided with longitudinally disposed dragger circular holes 31 for longitudinal feeding of the carrier tape assembly on one edge of upper surface of the carrier tape 30b wherein transversely-elongated square pockets 32b with parts 33b enclosed therein are disposed in the longitudinal direction of the carrier tape.

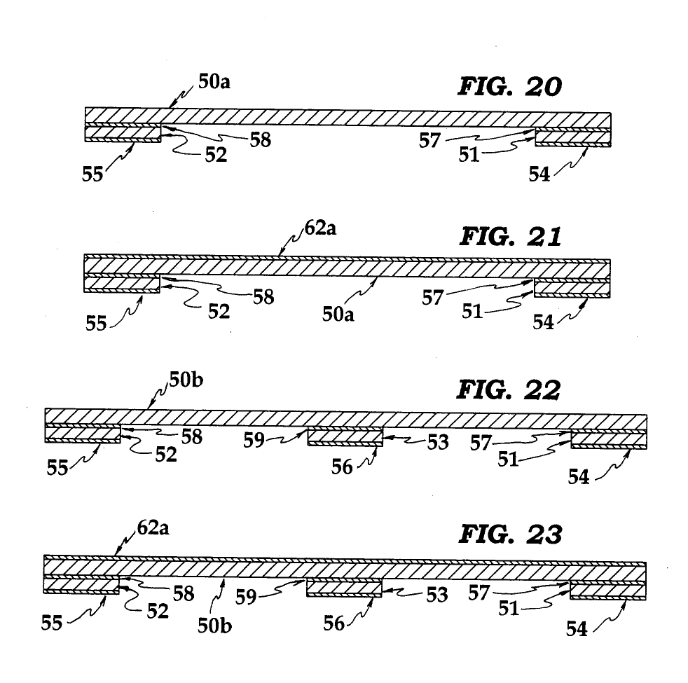

FIGS. 20 through 26 and 27 show cross-sectional embodiment of each of the cover tapes in accordance with the third version of the present invention. Cross-sectional embodiment of FIG. 20 is for a cover tape to be overlaid on a carrier tape for carrying parts enclosed in part-capturing means formed in the carrier tape and disposed typically in single row in the longitudinal direction of the carrier tape. The first cover tape in this version consists of: (a) a linear first base film 50a formed of flexible solid material, cross section of the first base film 50a being of a transversely elongated square along a longitudinal direction of the first base film 50a; (b) a linear first lining; and (c) a linear second lining. The first lining consists of (1) a first film 51 formed of flexible solid material and having a transversely elongated square cross section thereof along a longitudinal direction of the first film 51, (2) a first sticky lower lining 54 formed of sticky material and layered on lower surface of the first film 51, and (3) a first sticky upper lining 57 also formed of sticky material and layered on upper surface of the first film 51, upper surface of the first sticky upper lining 57 being stuck to a right portion of lower surface of the first base film 50a along the longitudinal direction of the first film 51. The second lining consists of (1) a second film 52 formed of flexible solid material and having a transversely elongated square cross section thereof along a longitudinal direction of the second film 52, (2) a second sticky lower lining 55 also formed of sticky material and layered on lower surface of the second film 52, and (3) a second sticky upper lining 58 formed of sticky material and layered on upper surface of the second film 52, upper surface of the second sticky upper lining 58 being stuck to a left portion of the lower surface of the first base film 50a along the longitudinal direction of the second film 52. So, when the cover tape is overlaid and born down hard on upper surface of the carrier tape wherein parts are captured, lower surface of each of the first sticky lower lining 54 and second sticky lower lining 55 is in tight contact with a portion of upper surface of the carrier tape along a longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

FIG. 21 is a cross-sectional embodiment of the cover tape of FIG. 20, further consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50a in the longitudinal direction of the first base film 50a.

Disclosed in FIG. 22 is a cross-sectional embodiment of the cover tape as disclosed in FIG. 20, further consisting of a linear third lining 53,56,59. This cover tape is for being overlaid on a carrier tape for carrying parts of two kinds or of a single kind enclosed in each of the first and second part-capturing means formed in the carrier tape and disposed in twin rows in a longitudinal direction of the cover tape. The third lining consists of (1) a third film 53 formed of flexible solid material and having a transversely elongated square cross section thereof along a longitudinal direction of the third film 53, (2) a third sticky lower lining 56 formed of sticky material and layered on lower surface of the third film 53, and (3) a third sticky upper lining 59 formed of sticky material and layered on upper surface of the third film 53, upper surface of the third sticky upper lining 59 being stuck to a portion of a middle portion of the lower surface of the first base film 50b along the longitudinal direction of the first base film 50b, the middle portion being transversely confined by the left and right portion of the lower surface of the first base film 50b along the longitudinal direction of the first base film 50b. With additional lamination of one said third lining, lower surface of the third sticky lower lining 56 is additionally in tight contact with a portion of the upper surface of the carrier tape so that when the cover tape is peeled off the carrier tape, the lower surface of each of the first sticky lining, the second sticky lining, and the third sticky lining, and the upper surface of the carrier tape is separated from each other along a longitudinal direction of the carrier tape. Here also, there may be more than one said linear third lining layered on the middle portion of the lower surface of the first base film 50a for carrying parts transversely disposed in more than two rows. It is also within the scope of the claims of the present invention that there are more than one part rows transversely confined either by the third lining and the first lining or by the second lining and the third lining.

Shown in FIG. 23 is a cross-sectional embodiment of the cover tape of FIG. 22, further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50b in the longitudinal direction of the first base film 50b.

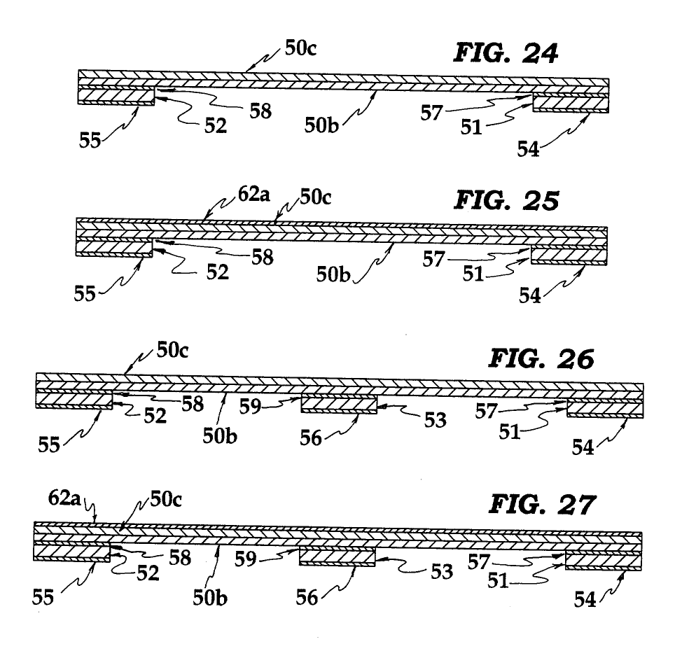

FIG. 24 discloses a cross-sectional embodiment of the cover tape of FIG. 20, further consisting of a linear second base film 50c, cross section of the second base film 50c being of a transversely elongated square along a longitudinal direction of the second base film 50c, the second base film 50c being adhered to the first base film 50b in such a way that lower surface of the second base film 50c is in tight contact with upper surface of the first base film 50b in the longitudinal direction of the first base film 50b such that each of the first base film 50b and the second base film 50c stays together unless external force is applied thereto. It is to be noted that at least one linear second base film may be adhered to the upper surface of the first base film 50b, which is duly within the scope of the claims of the present invention.

Revealed in FIG. 25 is a cross-sectional embodiment of the cover tape of FIG. 24, further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the second base film 50c in the longitudinal direction of the first base film 50b. This embodiment of the cross section of the cover tape is for a carrier tape wherein part-capturing means in single row is formed while each of the cross sections of the cover tape disclosed in FIGS. 26 and 27 is for carrier tapes wherein two rows of part-capturing means are disposed in the transverse direction of the carrier tape.

Disclosed in FIG. 26 is a cross-sectional embodiment of the cover tape as shown in FIG. 24, further more consisting of a one linear third lining 53,56,59. The cover tape is for being overlaid on a carrier tape for carrying parts of two kinds or a single kind enclosed in each of the first and second part-capturing means formed in the carrier tape and disposed in twin rows in a longitudinal direction of the cover tape. The third lining consists of (1) a third film 53 formed of flexible solid material and has a transversely elongated square cross section thereof along a longitudinal direction of the third film 53, (2) a third sticky lower lining 56 formed of sticky material and layered on lower surface of the third film 53, and (3) a third sticky upper lining 59 formed of sticky material and layered on upper surface of the third film 53, upper surface of the third sticky upper lining 59 being stuck to a portion of a middle portion of the lower surface of the first base film 50a along the longitudinal direction of the first base film 50a, the middle portion being transversely confined by the right portion and the left portion of the lower surface of the first base film 50a along the longitudinal direction of the first base film 50b. With additional lamination of one said third lining 53,56,59, lower surface of the third sticky lower lining 56 is additionally in tight contact with a portion of the upper surface of the carrier tape so that when the cover tape is peeled off the carrier tape, the lower surface of each of the first sticky lining 51,54,57, the second sticky lining 52,55,58, and the third sticky lining 53,56,59, and the upper surface of the carrier tape is separated from each other along a longitudinal direction of the carrier tape. Here also, there may be more than one said linear third lining laminated on the middle portion of the lower surface of the first base film 50a to be overlaid on a carrier tape for carrying parts transversely disposed in more than triple rows therewith. It is also within the scope of the claims of the present invention that there are part-capturing means in more than one row transversely confined by the third lining and the first lining and/or the second lining and the third lining.

Revealed in FIG. 27 is a cross-sectional embodiment of the cover tape of FIG. 26, further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film 50c in the longitudinal direction of the first base film 50b.

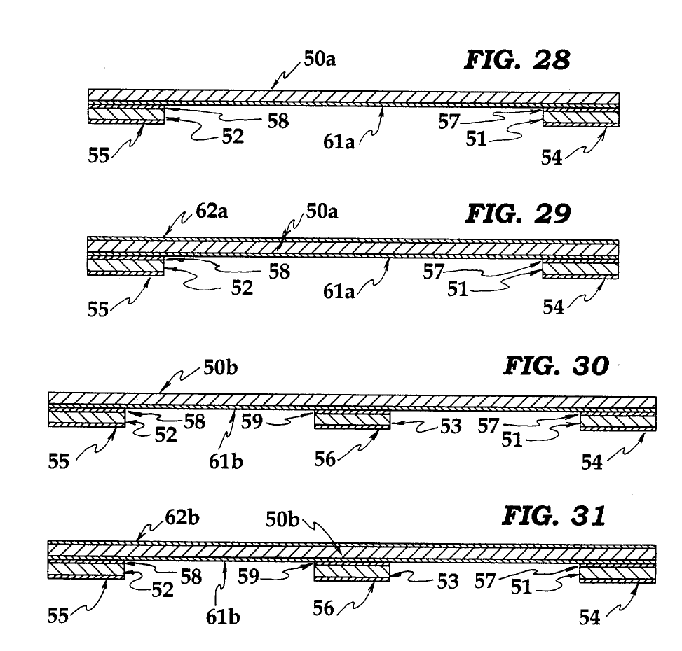

FIGS. 28 through 34 and 35 show cross-sectional embodiment of each of the cover tapes in accordance with fourth version of the present invention. Cross-sectional embodiment of FIG. 28 is for a cover tape for a carrier tape for carrying parts enclosed in part-capturing means formed in the carrier tape and disposed not necessarily limited to in single row in the longitudinal direction of the carrier tape as is the case for all cross-sectional embodiments wherein only the first and second lining are laminated. The first cover tape in this version consists of: (a) a linear first base film 50a formed of flexible solid material, cross section of the first base film 50a being of a transversely elongated square along a longitudinal direction of the first base film 50a; (b) a linear lower base-film coating 61a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film 50a; (c) a linear first lining; and (d) a linear second lining. The linear first lining consists of (1) a first film 51 formed of flexible solid material and having a transversely elongated square cross section thereof along a longitudinal direction of the first film 51, (2) a first sticky lower lining 54 formed of sticky material and layered on lower surface of the first film 51, and (3) a first sticky upper lining 57 formed of sticky material and layered on upper surface of the first film 51, upper surface of the first sticky upper lining 57 being stuck to a right portion of lower surface of the lower base-film coating 61a along the longitudinal direction of the first base film 50a. The linear second lining consists of (1) a second film 52 formed of flexible solid material and having a transversely elongated square cross section thereof along a longitudinal direction of the second film 52, (2) a second sticky lower lining 55 formed of sticky material and layered on lower surface of the second film 52, and (3) a second sticky upper lining 58 formed of sticky material and layered on upper surface of the second film 52, upper surface of the second sticky upper lining 58 being stuck to a left portion of the lower surface of the lower base-film coating 61a along the longitudinal direction of the first base film 50a. So, when the cover tape is overlaid and born down hard on upper surface of the carrier tape wherein parts are captured, lower surface of each of the first sticky lower lining 54 and second sticky lower lining 55 is in tight contact with a portion of upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining 54 and the second sticky lower lining 55, and the upper surface of the carrier tape separated from each other along the longitudinal direction of the carrier tape.

FIG. 29 discloses a cross-sectional embodiment of the cover tape of FIG. 28, further consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50a in the longitudinal direction of the first base film 50a.

Disclosed in FIG. 30 is a cross-sectional embodiment of the cover tape as shown in FIG. 28, further consisting of a linear third lining 53,56,59. The linear third lining consists of (1) a third film 53 formed of flexible solid material and having a transversely elongated square cross section thereof along a longitudinal direction of the third film 53, (2) a third sticky lower lining 56 formed of sticky material and layered on upper surface of the third film 53, and (3) a third sticky upper lining 59 formed of sticky material and layered on lower surface of the third film 53, upper surface of the third sticky upper lining 59 being stuck to a portion of a middle portion of the lower surface of the lower base-film coating 61b along the longitudinal direction of the first base film 50b, the middle portion being transversely confined by the right portion and the left portion of the lower surface of the lower base-film coating 61b along the longitudinal direction of the first base film 50b. With this cross-sectional embodiment, lower surface of the third sticky lower lining 56 is additionally in tight contact with a portion of the upper surface of the carrier tape so that when the cover tape is peeled off the carrier tape, the lower surface of each of the first sticky lower lining 54, the second sticky lower lining 55, and the third sticky lower lining 56, and the upper surface of the carrier tape is separated from each other along the longitudinal direction of the carrier tape. It is to be mentioned here that at least one said linear third lining comprising a third film 53, a third sticky lower lining 56, and a third sticky upper lining 59 can be disposed on the lower surface of the lower base-film coating 61b, which is again within the intended scope of the claims in compliance with the fourth version of the cover tapes of the present invention.

FIG. 31 shows a cross-sectional embodiment of the cover tape of FIG. 30, further consisting of a linear upper base-film coating 62b formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50b in the longitudinal direction of the first base film 50b.

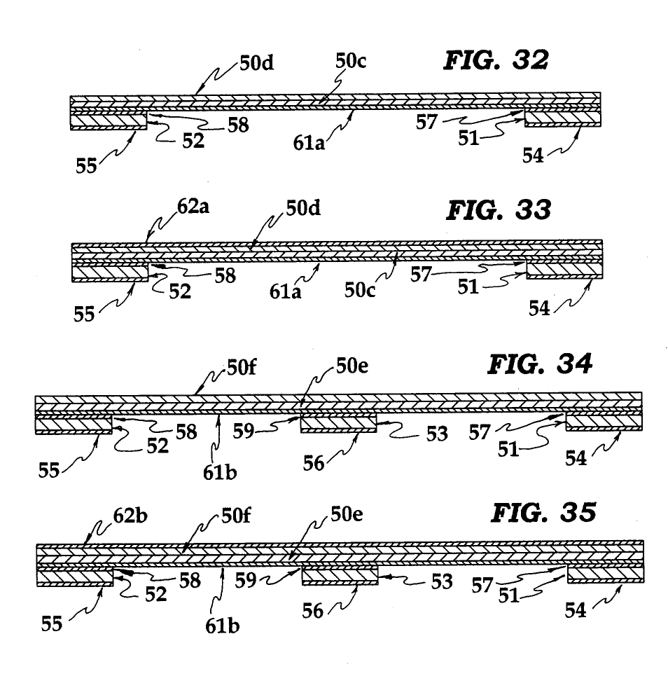

FIG. 32 discloses a cross-sectional embodiment of the cover tape of FIG. 28, further consisting of a linear second base film 50d. The second base film 50d is adhered to the first base film 50c in such a way that lower surface of the second base film 50d is in tight contact with upper surface of the lower base-film coating 61a in the longitudinal direction of the first base film 50c such that each of the first base film 50c and the second base film 50d stays together unless external force is applied thereto. Even though the magnitude of the breadth of the cover tape of FIGS. 32 and 33 is smaller than that for the cover tapes of either one of FIG. 34 or FIG. 35, it does not necessarily mean that the magnitude of the breadth of each of the former is smaller than that for the latter, which is true of all other cover tapes in the other versions of the cover tapes.

Shown in FIG. 33 is a cross-sectional embodiment of the cover tape disclosed in FIG. 32, further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film 50d in the longitudinal direction of the first base film 50c.

FIG. 34 reveals a cross-sectional embodiment of the cover tape as shown in FIG. 32, further more consisting of a linear second base film 50f, cross section of the second base film 50f being of a transversely elongated square along a longitudinal direction of the second base film 50f, the second base film 50f being adhered to the first base film 50e in such a way that lower surface of the second base film 50f is in tight contact with upper surface of the lower base-film coating 61b in the longitudinal direction of the first base film 50e.

FIG. 35 shows a cross-sectional embodiment of the cover tape of FIG. 34, further more consisting of a linear upper base-film coating 62b formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film 50f in the longitudinal direction of the first base film 50e.

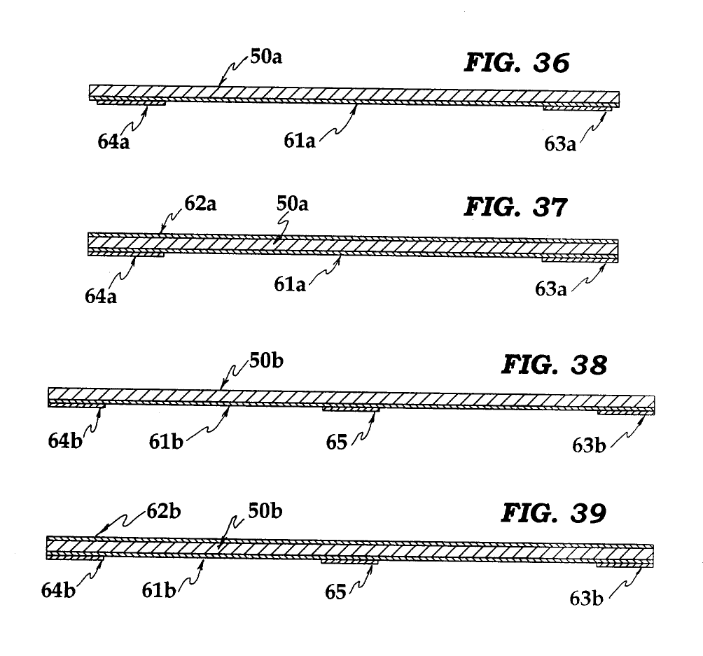

FIGS. 36 through 42 and 43 show cross-sectional embodiment of each of the cover tapes in accordance with fifth version of the present invention. Cross-sectional embodiment of FIG. 36 is for a cover tape for being overlaid on a carrier tape for carrying parts enclosed in part-capturing means formed in the carrier tape and disposed basically in single row in a longitudinal direction of the carrier tape. The first cover tape in this version consists of: (a) a linear first base film 50a formed of flexible solid material, cross section of the first base film being of a transversely elongated square along a longitudinal direction of the first base film; (b) a linear lower base-film coating 61a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film 50a along the longitudinal direction of the first base film 50a; (c) a linear first sticky lining 63a formed of sticky material and laminated on a right portion of lower surface of the lower base-film coating 61a along the longitudinal direction of the first base film 50a; and (d) a linear second sticky lining 64a formed of sticky material and laminated on a left portion of the lower surface of the lower base-film coating 61a along the longitudinal direction of the first base film 50a. The left and right portion of the lower surface of the lower base-film coating 61a transversely confines a middle portion of the lower surface of the lower base-film coating 61a along the longitudinal direction of the base film 50a. When the cover tape in this embodiment is overlaid and born down hard on upper surface of the carrier tape wherein parts are captured, lower surface of each of the first sticky lining 63a and second sticky lining 64a is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining 63a and the second sticky lining 64a, and the upper surface of the carrier tape separated from each other along the longitudinal direction of the carrier tape.

FIG. 37 discloses a cross-sectional embodiment of the cover tape of FIG. 36, further consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50a in the longitudinal direction of the first base film 50a.

Given in FIG. 38 is a cross-sectional embodiment of the cover tape as disclosed in FIG. 36, further consisting of a linear third sticky lining 65. The third sticky lining 65 is formed of sticky material and laminated on a portion of the middle portion of the lower surface of the lower base-film coating 61b along the longitudinal direction of the first base film 50b, whereby lower surface of the third sticky lining 65 is additionally in tight contact with a portion of the upper surface of the carrier tape so that when the cover tape is peeled off the carrier tape, the lower surface of each of the first sticky lining 63b, the second sticky lining 64b, and the third sticky lining 65, and the upper surface of the carrier tape is separated from each other along the longitudinal direction of the carrier tape. It is to be noted that at least one linear third sticky lining 65, . . . may be laminated on the lower surface of the lower base-film coating 61b to take care of as many rows of part-capturing means disposed on upper surface of the carrier tape as the third sticky lining 65, . . . , which is accordingly within the scope of the claims of the present invention.

FIG. 39 is a cross-sectional embodiment of the cover tape of FIG. 38, further more consisting of a linear upper base-film coating 62b formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50b in the longitudinal direction of the first base film 50b.

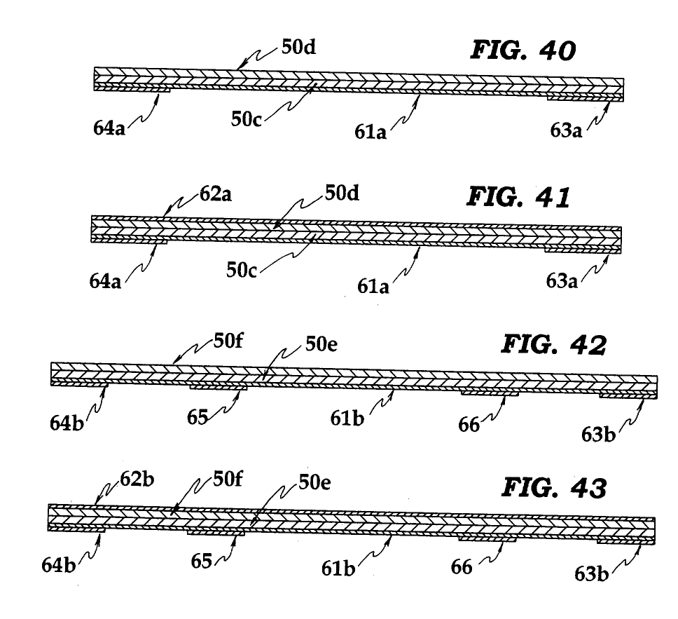

Shown in FIG. 40 is a cross-sectional embodiment of the cover tape of FIG. 36, further consisting of a linear second base film 50d. Cross section of the second base film 50d is of a transversely elongated square along a longitudinal direction of the second base film 50d, the second base film 50d being adhered to the first base film 50c in such a way that lower surface of the second base film 50d is in tight contact with upper surface of the first base film 50c in the longitudinal direction of the first base film 50c such that each of the first base film 50c and the second base film 50d stays together unless external force is applied thereto. Within the scope of the claims of the present invention is that there are at least one linear second base film 50d, . . . , each of the second base films being adhered to one another in such a way that lower surface of the second base film disposed lowermost is adhered to the upper surface of the first base film 50c.

FIG. 41 is a cross-sectional embodiment of the cover tape of FIG. 40, further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film 50d in the longitudinal direction of the first base film 50c.

Disclosed in FIG. 42 is a cross-sectional embodiment of the cover tape as disclosed in FIG. 40, further more consisting of two linear third sticky linings 65,66, each of the third sticky linings 65,66 being formed of sticky material and laminated on a portion of the middle portion of the lower surface of the lower base-film coating 61b along the longitudinal direction of the first base film 50e, whereby lower surface of each of the two third sticky linings 65,66 is additionally in tight contact with a portion of the upper surface of the carrier tape so that when the cover tape is peeled off the carrier tape, the lower surface of each of the first sticky lining 63b, the second sticky lining 64b, and each of the two third sticky linings 65,66, and the upper surface of the carrier tape is separated from each other along the longitudinal direction of the carrier tape.

FIG. 43 shows a cross-sectional embodiment of the cover tape of FIG. 42, still further more consisting of a linear upper base-film coating 62b formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film 50f in the longitudinal direction of the first base film 50e.

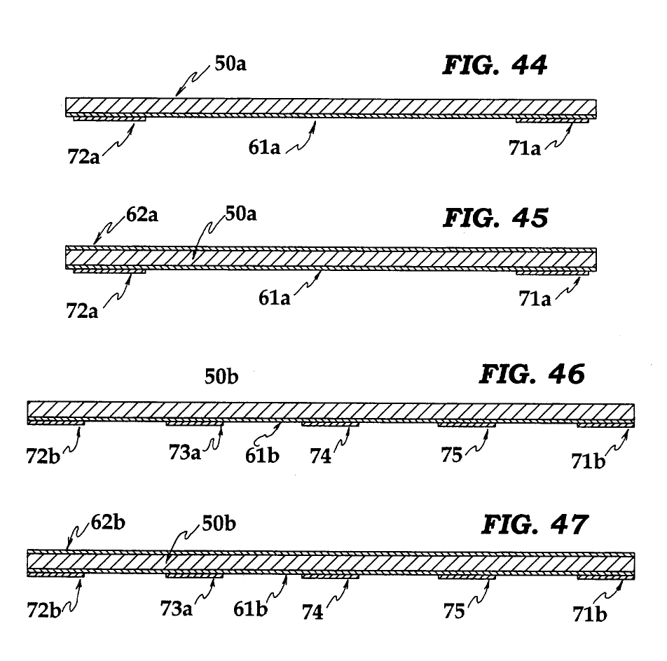

FIGS. 44 through 50 and 51 reveal cross-sectional embodiment of each of the cover tapes in accordance with sixth version of the present invention. Cross-sectional embodiment of FIG. 44 is for a cover tape to be overlaid on a carrier tape for carrying parts enclosed in part-capturing means formed in the carrier tape and disposed typically in single row in a longitudinal direction of the carrier tape. The first cover tape in this version consists of: (a) a linear first base film 50a formed of flexible solid material, cross section of the first base film 50a being of a transversely elongated square along a longitudinal direction of the first base film 50a; (b) a linear lower base-film coating 61a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film 50a along the longitudinal direction of the first base film 50a; (c) a linear first non-sticky lining 71a; and (d) a linear second non-sticky lining 72a. The first non-sticky lining 71a is formed of non-sticky material inclusive of what-is-called “Hot-Melt” and laminated on a right portion of lower surface of the lower base-film coating 61a along the longitudinal direction of the first base film 50a while the second non-sticky lining 72a is also formed of non-sticky material and laminated on a left portion of the lower surface of the lower base-film coating 61a along the longitudinal direction of the first base film 50a. The right portion and the left portion of the lower surface of the lower base-film coating 61a transversely confines a middle portion of the lower surface of the lower base-film coating 61a along the longitudinal direction of the base film 50a. When the cover tape in this cross section is overlaid and heat-staked on upper surface of the carrier tape wherein parts are captured, lower surface of each of the first non-sticky lining 71a and second non-sticky lining 71b is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining 71a and the second non-sticky lining 72a, and the upper surface of the carrier tape separated from each other along the longitudinal direction of the carrier tape.

FIG. 45 shows a cross-sectional embodiment of the cover tape of FIG. 44, further consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film 50a in a longitudinal direction of the first base film 50a.

Revealed in FIG. 46 is a cross-sectional embodiment of the cover tape as disclosed in FIG. 44, further consisting of three linear third non-sticky linings 73a,74,75. Each of the third non-sticky linings 73a,74,75 is formed of non-sticky material and laminated on a portion of the middle portion of the lower surface of the lower base-film coating 61a along the longitudinal direction of the first base film 50b; whereby lower surface of each of the third non-sticky linings 73a,74,75 is additionally in tight contact with a portion of the upper surface of the carrier tape so that when the cover tape is peeled off the carrier tape, the lower surface of each of the first non-sticky lining 71a, the second non-sticky lining 72a, and each of the third non-sticky linings 73a,74,75, and the upper surface of the carrier tape is separated from each other along the longitudinal direction of the carrier tape.

FIG. 47 shows a cross-sectional embodiment of the cover tape of FIG. 46, further more consisting of a linear upper base-film coating 62b formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film 50a in a longitudinal direction thereof.

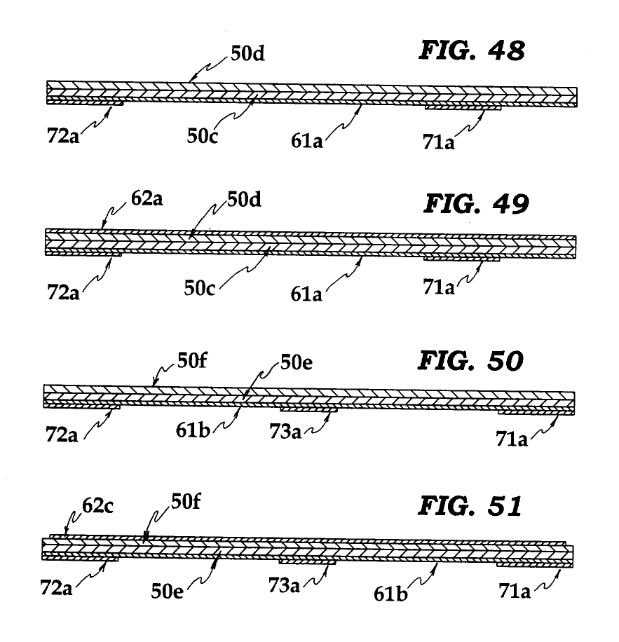

Disclosed in FIG. 48 is a cross-sectional embodiment of the cover tape of FIG. 44, further consisting of a linear second base film 50d, cross section of the second base film 50d being of a transversely elongated square along a longitudinal direction of the second base film 50d, the second base film 50d being adhered to the first base film 50c in such a way that lower surface of the second base film 50d is in tight contact with upper surface of the first base film 50c in the longitudinal direction of the first base film 50c such that each of the first base film 50c and the second base film 50d stays together unless external force is applied thereto. Note that at least one linear second base film 50d, . . . can be adhered to the upper surface of the first base film 50c, which is again within the scope of the claims of the present invention.

FIG. 49 is a cross-sectional embodiment of the cover tape of FIG. 48 further more consisting of a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second base film 50d in the longitudinal direction of the first base film 50c.

FIG. 50 shows a cross-sectional embodiment of the cover tape of FIG. 46, further consisting of a linear second base film 50f with only one said third non-sticky linings 73a laminated on the lower surface of the lower base-film coating 61b. Cross section of the second base film 50f is of a transversely elongated square along a longitudinal direction of the second base film 50f. The second base film 50e is adhered to the first base film 50e in such a way that lower surface of the second base film 50f is in tight contact with upper surface of the first base film 50e in the longitudinal direction thereof such that each of the first base film 50e and second base film 50f stays together unless external force is applied thereto. More than one said second base film 50f, . . . may be adhered to the first base film 50e, which is also again within the intended scope of the claims of the present invention.

FIG. 51 discloses a cross-sectional embodiment of the cover tape of FIG. 50, further more consisting of a linear upper base-film coating 62c formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on entire upper surface or on a portion of the upper surface of the second base film 50f disposed uppermost in the longitudinal direction of the first base film 50e.

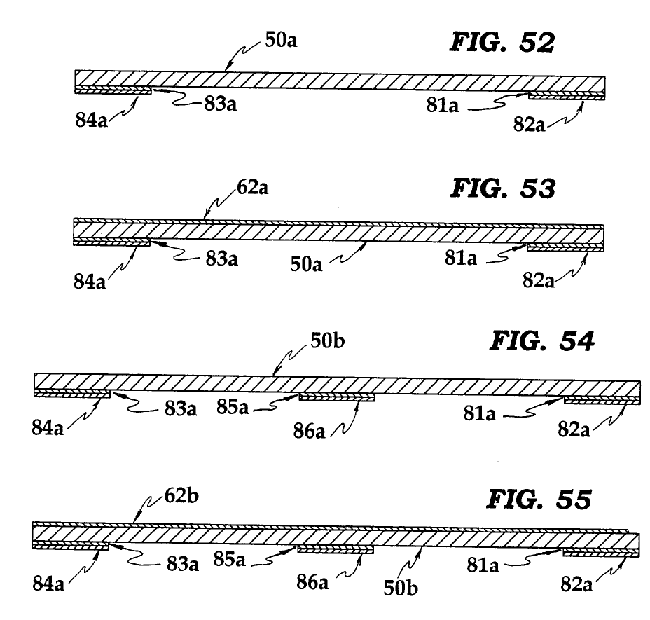

FIGS. 52 through 58 and 59 reveal cross-sectional embodiment of each of the cover tapes in accordance with seventh version of the present invention. Cross-sectional embodiment of FIG. 52 is for a cover tape to be overlaid on a carrier tape for carrying parts enclosed in part-capturing means formed in the carrier tape and disposed typically in single row in a longitudinal direction of the carrier tape. The first cover tape in this version consists of: (a) a linear first base film 50a formed of flexible solid material, cross section of the first base film 50a being of a transversely elongated square along a longitudinal direction of the first base film 50a; (b) a first combinational lining consisting of (1) a first non-sticky lining 81a formed of non-sticky material, and (2) a first sticky lining 82a formed of sticky material and layered on lower surface of the first non-sticky lining 81a along the longitudinal direction of the first non-sticky lining 81a, the first non-sticky lining 81a being laminated on a right portion of lower surface of the first base film 50a along the longitudinal direction of the first base film 50a; and (c) a second combinational lining comprising: (1) a second non-sticky lining 83a formed of non-sticky material, and (2) a second sticky lining 84a formed of sticky material and layered on lower surface of the second non-sticky lining 83a along the longitudinal direction of the second non-sticky lining 83a, the second non-sticky lining 84a being laminated on a left portion of the lower surface of the first base film 50a along the longitudinal direction of the first base film 50a; whereby when the cover tape is overlaid and born down hard on upper surface of the carrier tape wherein parts are captured, lower surface of each of the first combinational lining and the second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining 81a,82a and the second combinational lining 83a,84a, and the upper surface of the carrier tape separated from each other along the longitudinal direction of the carrier tape.

FIG. 53 is a cross-sectional embodiment of the cover tape of FIG. 52 further consisting of a linear upper base-film coating 62a formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50a in the longitudinal direction of the first base film 50a.

Disclosed in FIG. 54 is a cross-sectional embodiment of the cover tape as disclosed in FIG. 52 further consisting of a third combinational lining. The third combinational lining consisting of (1) a third non-sticky lining 85a formed of non-sticky material, and (2) a third sticky lining 86a formed of sticky material and layered on lower surface of the third non-sticky lining 85a along the longitudinal direction of the third non-sticky lining 85a, the third non-sticky lining 85a being laminated on a portion of a middle portion of the lower surface of the first base film 50a along the longitudinal direction of the first base film 50a; whereby lower surface of the third combinational lining 85a,86a is additionally in tight contact with a portion of the upper surface of the carrier tape so that when the cover tape is peeled off the carrier tape, the lower surface of the first combinational lining 81a,82a, the second combinational lining 83a,84a, and the third combinational lining 85a,86a, and the upper surface of the carrier tape is separated from each other along the longitudinal direction of the carrier tape. The middle portion of the lower surface of the first base film 50a is transversely confined by the left portion and the right portion of the lower surface of the first base film 50b. At least one third combinational lining may be adhered to the lower surface of the first base film 50b, which is within the scope of the claims of the present invention.

Shown in FIG. 55 is a cross-sectional embodiment of the cover tape as shown in FIG. 55, further consisting of a linear upper base-film coating 62b formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 52b in the longitudinal direction of the first base film 52b.

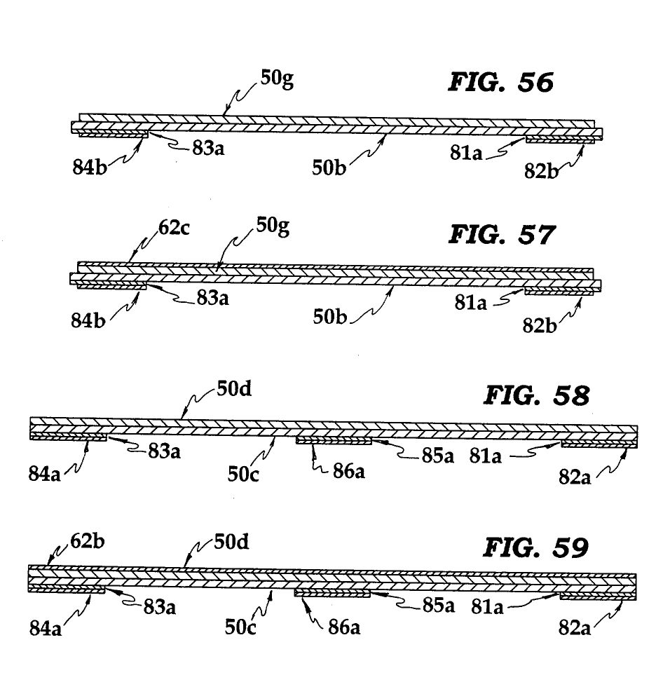

FIG. 56 is a cross-sectional embodiment of the cover tape of FIG. 52, further consisting of a linear second base film 50g, wherein the first sticky lining 82b and the second sticky lining 84b is not layered on the entire lower surface of the first sticky lining 82a and the second sticky lining 84b as shown in each of FIGS. 52, 53, 54, and 55. One of merits for this kind of cross-sectional embodiment is that when the cover tape is taken up on a bobbin, both of two side surfaces of the cover-tape roll do not gather dusts thereon, which is not necessarily limited to the cover tape with this cross-sectional embodiment but applied to each of all other cover tapes wherein sticky lining is concerned within the scope of the claims of the present invention. Cross section of the second base film 50g is of a transversely elongated square along a longitudinal direction thereof, and the second base film 50g is adhered to the first base film 50b in such a way that lower surface of the second base film 50g is in tight contact with upper surface of the first base film 50b in the longitudinal direction of the first base film 50b such that each of the first base film 50b and the second base film 50g stays together unless external force is applied thereto. Here, at least one linear second base film may be adhered to the first base film 50b.

Revealed in FIG. 57 is a cross-sectional embodiment of the cover tape of FIG. 56, still further more consisting of a linear upper base-film coating made of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the second base film 50g in the longitudinal direction of the first base film 50b.

FIG. 58 shows a cross-sectional embodiment of the cover tape of FIG. 54, further more consisting of a linear second base film 50d. Cross section of the second base film 50d is of transversely elongated square along a longitudinal direction thereof and is adhered to the first base film 50c in such a way that lower surface of the second base film 50d is in tight contact with upper surface of the first base film 50c in the longitudinal direction of the first base film 50c such that each of the first base film 50c and the second base film 50d stays together unless external force is applied thereto. More than one said second base film including this embodiment of the second base film 50d may be adhered to the first base film 50c, which is still within the scope of the claims of the present invention.

FIG. 59 shows a cross-sectional embodiment of the cover tape of FIG. 58, still further more consisting of a linear upper base-film coating 62b formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the second base film 50d in the longitudinal direction of the first base film 50c.

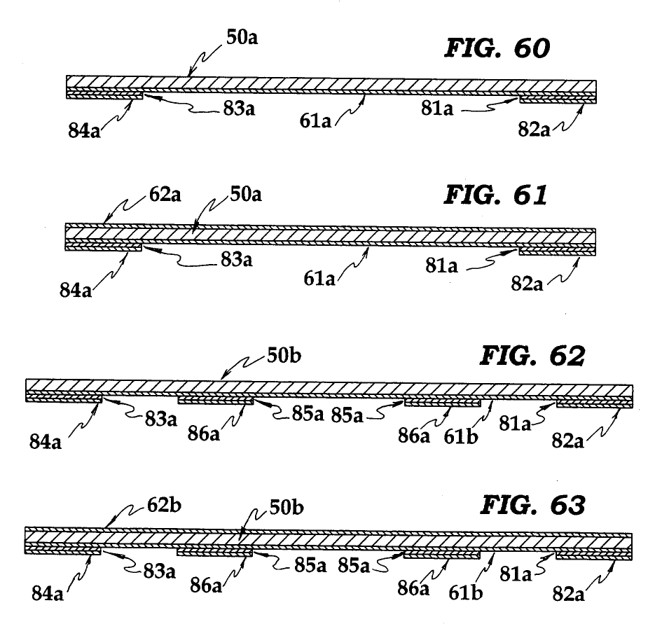

FIGS. 60 through 66 and 67 reveal cross-sectional embodiment of each of the cover tapes in accordance with eighth version of the present invention. Cross-sectional embodiment of each of FIGS. 60 and 61 is for a cover tape to be overlaid on a carrier tape for carrying parts enclosed in part-capturing means formed in the carrier tape and disposed conventionally in single row in a longitudinal direction of the carrier tape while that of each of FIGS. 62 and 63 is for a cover tape to be overlaid on the carrier tape for carrying parts enclosed in part-capturing means formed in the carrier tape and disposed typically in triple rows in the longitudinal direction of the carrier tape. The first cover tape of FIG. 60 consists of: (a) a linear first base film 50a formed of flexible solid material, cross section of the first base film being of a transversely elongated square along a longitudinal direction of the first base film 50a; (b) a linear lower base-film coating 61a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film 50a along the longitudinal direction of the first base film 50a; (c) a first combinational lining; and (d) a second combinational lining. The first combinational lining consists of (1) a first non-sticky lining 81a formed of non-sticky material, and (2) a first sticky lining 82a formed of sticky material and layered on lower surface of the first non-sticky lining 81a along the longitudinal direction of the first non-sticky lining 81a, the first non-sticky lining 81a being laminated on a right portion of lower surface of the lower base-film coating 61a along the longitudinal direction of the first base film 50a. The second combinational lining consists of (1) a second non-sticky lining 83a formed of non-sticky material, and (2) a second sticky lining 84a formed of sticky material and layered on lower surface of the second non-sticky lining 83a along the longitudinal direction of the second non-sticky lining 83a, the second non-sticky lining 83a being laminated on left portion of lower surface of the lower base-film coating 61a along the longitudinal direction of the first base film 50a. When the cover tape is overlaid and born down hard on upper surface of the carrier tape wherein parts are captured, lower surface of each of the first and second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining and the second combinational lining, and the upper surface of the carrier tape separated from each other along the longitudinal direction of the carrier tape.

FIG. 61 is a cross-sectional embodiment of the cover tape of FIG. 60, further consisting of a linear upper base-film coating 62a formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50a in the longitudinal direction of the first base film 50a.

FIG. 62 discloses a cross-sectional embodiment of the cover tape of FIG. 60 further consisting of two third combinational linings, each of the third combinational linings comprising (1) a third non-sticky lining 85a formed of non-sticky material, and (2) a third sticky lining 86a formed of sticky material and layered on lower surface of the third non-sticky lining 85a along the longitudinal direction of the third non-sticky lining 85a, the third non-sticky lining 85a being laminated on a portion of the middle portion of the lower surface of the lower base-film coating 61b along the longitudinal direction of the first base film 61b; whereby lower surface of each of the third combinational linings is additionally in tight contact with a portion of the upper surface of the carrier tape so that when the cover tape is peeled off the carrier tape, the lower surface of each of the first combinational lining 81a,82a, the second combinational lining 83a,84a, and each of the two third combinational linings 85a,86a, and the upper surface of the carrier tape is separated from each other along the longitudinal direction of the carrier tape. More than one third combinational lining may be attached to the lower surface of the lower base-film coating 61b.

FIG. 63 is the cross-sectional embodiment of the cover tape of FIG. 62 further consisting of a linear upper base-film coating 62b formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50b in the longitudinal direction of the first base film 50b.

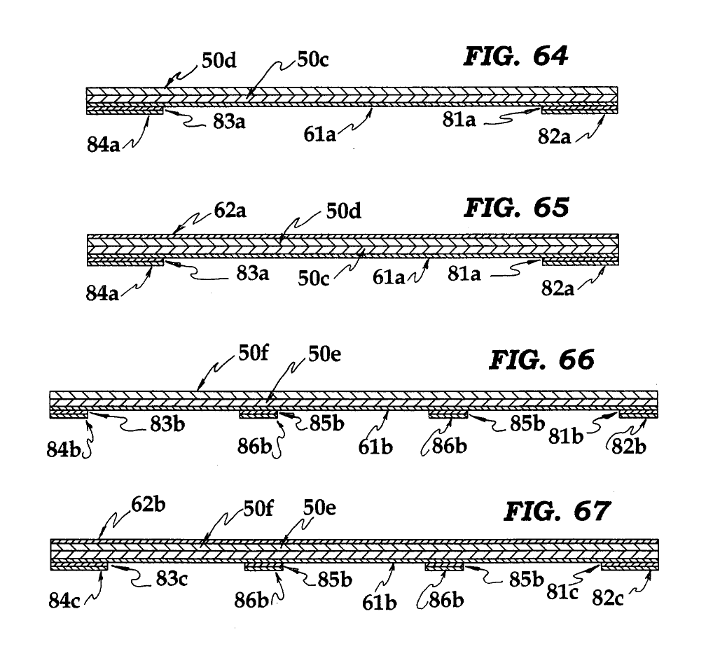

FIG. 64 is the cross-sectional embodiment of the cover tape of FIG. 60, further consisting of a linear second base film 50d. Cross section of the second base film 50d is of a transversely elongated square along a longitudinal direction of the second base film 50d, each of the second base films being adhered to the first base film 50c in such a way that lower surface of the second base film 50d is in tight contact with upper surface of the first base film 50c in the longitudinal direction of the first base film 50c such that each of the first base film 50c and the second base film 50d stays together unless external force is applied thereto.

FIG. 65 shows a cross-sectional embodiment of the cover tape of FIG. 60, further more consists of a linear upper base-film coating 62a formed of one selected from a group consisting of: (1) anti-static material formed of at least one selected from a group consisting of carbon, metal, metal oxide, positive ion, negative ion, non-ion, and conductor inclusive of organic polymer; (2) coloring agent as for opacity or for identification purposes; and (3) release agent, and layered on upper surface of the second base film 50d in the longitudinal direction of the first base film 50c.

FIG. 66 is a cross-sectional embodiment of the cover tape of FIG. 62, further consisting of a linear second base film 50f adhered to upper surface of the first base film 50e in such a way that lower surface of the second base film 50f is in tight surface contact with upper surface of the first base film 50e in the longitudinal direction of the first base film 50e. One intended use for the second base film is as for provision of stiffness to the first base film 50e, for example.

FIG. 67 discloses a cross-sectional embodiment of the cover tape of FIG. 66 with a linear upper base-film coating 62f formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the second base film 50f in the longitudinal direction of the first base film 50e.

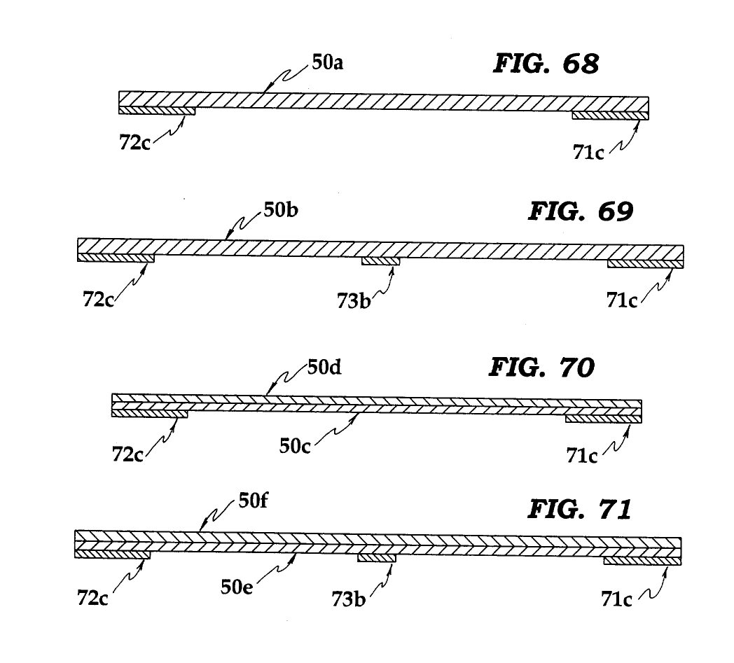

FIGS. 68 through 70 and 71 reveal cross-sectional embodiment of each of the cover tapes in accordance with ninth version of the present invention. Cross-sectional embodiment of FIG. 68 is for a cover tape to be overlaid on a carrier tape for carrying parts enclosed in part-capturing means formed in the carrier tape and disposed typically in single row in a longitudinal direction of the carrier tape. The cover tape shown in FIG. 68 consists of: (a) a linear first base film 50a formed of flexible solid material, cross section of the first base film 50a being of a transversely elongated square along a longitudinal direction of the first base film 50a; (b) a linear first non-sticky lining 71c formed of non-sticky material and laminated on a right portion of lower surface of the first base film 50a along the longitudinal direction of the first base film 50a; and (c) a linear second non-sticky lining 72c also formed of non-sticky material and laminated on a left portion of the lower surface of the first base film 50a along the longitudinal direction of the first base film 50a; whereby when the cover tape is overlaid and heat-staked on upper surface of the carrier tape wherein parts are captured, lower surface of each of the first non-sticky lining 71c and second non-sticky lining 72c is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining 71c and the second non-sticky lining 72c, and the upper surface of the carrier tape separated from each other along the longitudinal direction of the carrier tape.

FIG. 69 shows derivative cross-sectional embodiment of the cover tape of FIG. 68, further consisting of a linear third non-sticky lining 73b. The third non-sticky lining 73b is formed of non-sticky material and laminated on a portion of a middle portion of the lower surface of the first base film 50a along the longitudinal direction of the first base film 50a. Here, the middle portion is transversely confined by the right portion and left portion of the lower surface of the first base film 50a. With this cross-sectional embodiment of the cover tape, lower surface of the third non-sticky lining is additionally in tight contact with a portion of the upper surface of the carrier tape so that when the cover tape is peeled off the carrier tape, the lower surface of the first non-sticky lining 71c, the second non-sticky lining 72c, and the third non-sticky lining 73b, and the upper surface of the carrier tape is separated from each other along the longitudinal direction of the carrier tape.

FIG. 70 shows a cross-sectional embodiment of the cover tape of FIG. 68, further consisting of a linear second base film 50d. The second base film 50d is adhered to the first base film 50c in such a way that lower surface of the second base film 50d is in tight contact with upper surface of the first base film 50c in the longitudinal direction of the first base film 50c such that each of the first base film 50c and the second base film 50d stays together unless external force is applied thereto.

Disclosed in FIG. 71 is a cross-sectional embodiment of the cover tape of FIG. 69, further more consisting of a linear second base film 50f. The second base film 50f is adhered to the first base film 50e in such a way that lower surface of the second base film 50f is in tight contact with upper surface of the first base film 50e in the longitudinal direction of the first base film 50e such that each of the first base film 50e and the second base film 50f stays together unless external force is applied thereto.

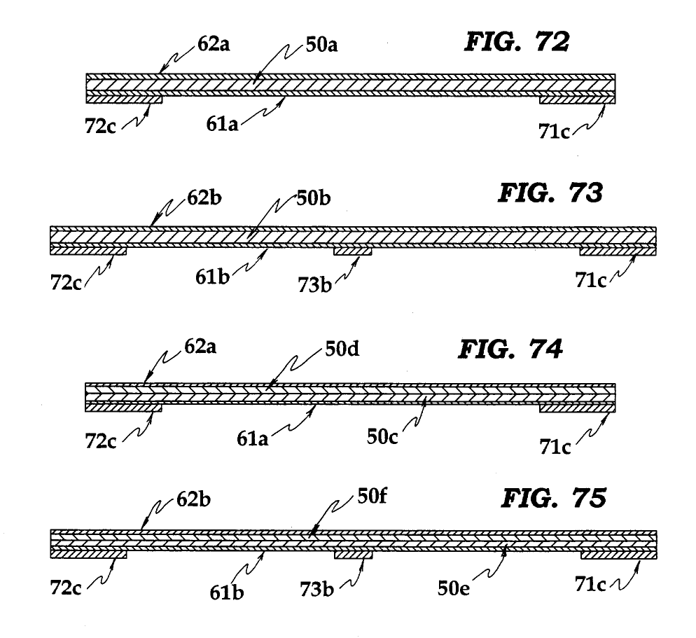

FIGS. 72 through 74 and 75 reveal cross-sectional embodiment of each of the cover tapes in accordance with tenth version of the present invention. The first cover tape in this version of the cover tape as shown in FIG. 72 consists of (a) a linear first base film 50a formed of flexible solid material, cross section of the first base film being of a transversely elongated square along a longitudinal direction of the first base film 50a; (b) a linear lower base-film coating 61a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film 50a along the longitudinal direction of the first base film 50a; (c) a linear first non-sticky lining 71c formed of non-sticky material and laminated on a right portion of lower surface of the lower base-film coating 61a along the longitudinal direction of the first base film 50a; (d) a linear second non-sticky lining 72c formed of non-sticky material and laminated on a left portion of the lower surface of the lower base-film coating 61a along the longitudinal direction of the first base film 50a; and (e) a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film 50a in the longitudinal direction of the first base film 50a; whereby when the cover tape is overlaid and heat-staked on upper surface of the carrier tape wherein parts are captured, lower surface of each of the first non-sticky lining 71c and second non-sticky lining 72c is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with the lower surface of each of the first non-sticky lining 71c and the second non-sticky lining 72c, and the upper surface of the carrier tape separated from each other along the longitudinal direction of the carrier tape.

FIG. 73 discloses a cross-sectional embodiment of the cover tape as shown in FIG. 72, further consisting of a linear third non-sticky lining 73b formed of non-sticky material and laminated on a middle portion of the lower surface of the lower base-film coating 61b along the longitudinal direction of the first base film 50b. The middle portion is transversely confined by the right portion and the left portion of the lower surface of the lower base-film coating 61b along the longitudinal direction of the first base film 50b. When this cover tape is overlaid on a carrier tape wherein two rows of part-capturing means is longitudinally disposed in the transverse direction of the cover tape, lower surface of the third non-sticky lining 73b is additionally in tight contact with a portion of the upper surface of the carrier tape so that when the cover tape is peeled off the carrier tape, the lower surface of each of the first non-sticky lining 71c, the second non-sticky lining 72c, and the third non-sticky lining 73b, and the upper surface of the carrier tape is separated from each other along the longitudinal direction of the carrier tape. More than one row of the part-capturing means can be longitudinally disposed in the transverse direction of the carrier tape that is confined by the first non-sticky lining 71c and the third non-sticky lining 73b, for example.

FIG. 74 shows a cross-sectional embodiment of a cover tape, wherein a second base film 50d is disposed in between the upper base-film coating 62a and the first base film 50a as shown in FIG. 72 while FIG. 75 discloses a cross-sectional embodiment of a cover tape, wherein a second base film 50f is disposed in between the upper base-film coating 62b and the first base film 50b as shown in FIG. 73. More than one said second base film may be disposed in between the upper base-film coating 62a,62b and the first base film 50c,50e, which are also bounded by the scope of the claims of the present invention.

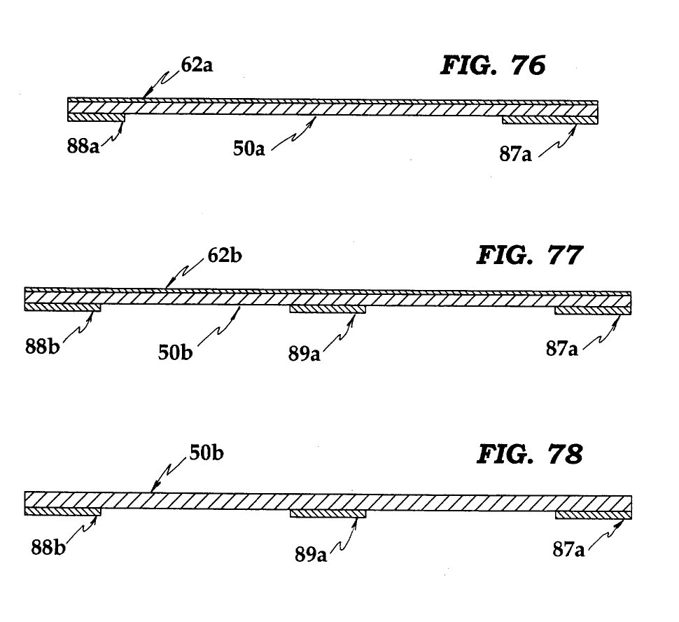

FIGS. 76 through 81 and 82 disclose a cross-sectional embodiment of various cover tapes in compliance with final eleventh version. FIG. 76 is a cross-sectional embodiment of a cover tape consisting of (a) a linear first base film 50a formed of flexible solid material, cross section of the first base film being of a transversely elongated square along a longitudinal direction of the first base film 50a; (b) a linear upper base-film coating 62a formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film 50a in the longitudinal direction of the first base film 50a; (c) a linear first sticky lining 87a formed of sticky material and laminated on a right portion of lower surface of the first base film 50a along the longitudinal direction of the first base film 50a; and (d) a linear second sticky lining 88a formed of sticky material and laminated on a left portion of the lower surface of the first base film 50a along the longitudinal direction of the first base film 50a; whereby when the cover tape is overlaid and born down hard on upper surface of the carrier tape wherein parts are captured, lower surface of each of the first sticky lining 87a and second sticky lining 88b is in tight contact with a portion of the upper surface of the carrier tape along the longitudinal direction of the carrier tape so that each of the parts captured in between the cover tape and the carrier tape in at least single row can be carried over to a place intended therefor to be ready to be taken out as the cover tape is peeled off the carrier tape with the lower surface of each of the first sticky lining 87a and the second sticky lining 88b, and the upper surface of the carrier tape separated from each other along the longitudinal direction of the carrier tape.

FIG. 77 is a cross-sectional embodiment of the cover tape of FIG. 76, further consisting of a linear third sticky lining 89a formed of sticky material and laminated on a portion of a middle portion of the lower surface of the first base film 50b along the longitudinal direction of the first base film 50b. The middle portion is transversely confined by the right portion and the left portion of the lower surface of the first base film 50b. When this cover tape is used, lower surface of each of the first, second and third sticky lining 87a,88b,89a becomes in tight contact with a portion of the upper surface of the carrier tape so that when the cover tape is peeled off the carrier tape, the lower surface of each of the first sticky lining 87a, the second sticky lining 88b, and the third sticky lining 89a, and the upper surface of the carrier tape is separated from each other along the longitudinal direction of the carrier tape.

FIG. 78 is a cross-sectional embodiment of the third cover tape in accordance with the eleventh version of the present invention. The cover tape comprises: (a) a linear first base film 50b formed of flexible solid material, cross section of the first base film 50b being of a transversely elongated square along a longitudinal direction of the first base film 50b; (b) a linear first sticky lining 87a formed of sticky material and laminated on a right portion of lower surface of the first base film 50b along the longitudinal direction of the first base film 50b; (c) a linear second sticky lining 88b formed of sticky material and laminated on a left portion of the lower surface of the first base film 50b along the longitudinal direction of the first base film 50b; and (d) at least one linear third sticky lining 89a, . . . each of the third sticky linings 89a, . . . being formed of sticky material and laminated on a portion of a middle portion of the lower surface of the first base film along the longitudinal direction of the first base film 50b, the middle portion being transversely confined by the right portion and the left portion of the lower surface of the first base film 50b; whereby when the cover tape is overlaid and born down hard on upper surface of the carrier tape wherein parts in at least two rows in the longitudinal direction of the carrier tape are captured, lower surface of each of the first sticky lining 87a, the second sticky lining 88b, and each of the third sticky linings 89a, . . . is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining 87a, the second sticky lining 88b, and each of the third sticky linings 89a, . . . , and the upper surface of the carrier tape separated from each other along the longitudinal direction of the carrier tape.

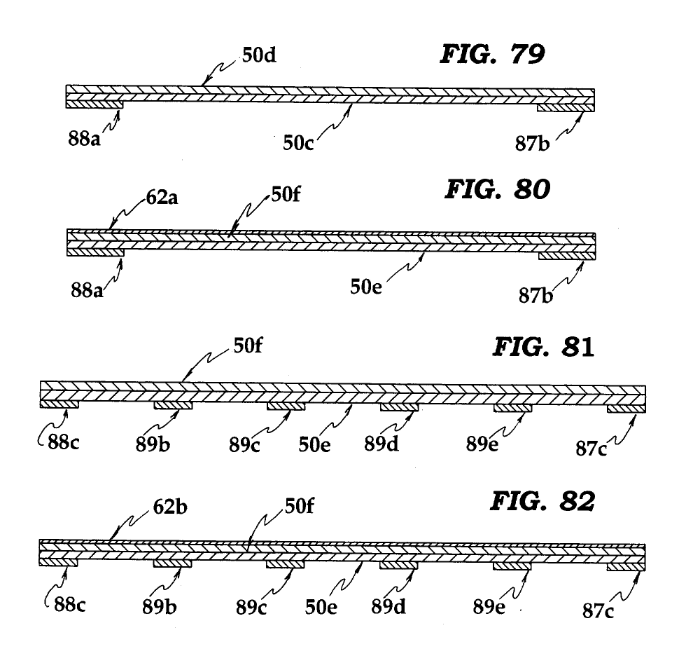

FIG. 79 shows a cross-sectional embodiment of a cover tape to be overlaid on a carrier tape wherein part-capturing means disposed conventionally in single row is formed. The cover tape consists of (a) a linear first base film 50c formed of flexible solid material, (b) at least one linear second base film 50d also formed of flexible solid material, each of the second base films 50d, . . . being adhered to the first base film 50d in such a way that lower surface of the second base film 50d disposed lowermost is in tight contact with upper surface of the first base film 50c in the longitudinal direction of the first base film 50c such that each of the first base film 50c and each of the second base films 50d, . . . stays together unless external force is applied thereto; (c) a linear first sticky lining 87b formed of sticky material and laminated on a right portion of lower surface of the first base film 50c along the longitudinal direction of the first base film 50c; and (d) a linear second sticky lining 88a formed of sticky material and laminated on a left portion of the lower surface of the first base film 50c along the longitudinal direction of the first base film 50c; whereby when the cover tape is overlaid and born down hard on upper surface of the carrier tape wherein parts are captured, lower surface of each of the first sticky lining 87b and second sticky lining 88a is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining 87b and the second sticky lining 88a, and the upper surface of the carrier tape separated from each other along the longitudinal direction of the carrier tape.

FIG. 80 discloses a cross-sectional embodiment of the cover tape of FIG. 79, further consisting of a linear upper base-film coating 61a formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50f in the longitudinal direction of the first base film 50e.

Illustrated in FIG. 81 is a cross-sectional embodiment of a derivative of the cover tape as shown in FIG. 79, wherein the cover tape further consists of at least one linear third sticky lining 89b,89c,89d,89e, . . . each of the third sticky linings 89b,89c,89d,89e, . . . being formed of sticky material and laminated on a portion of a middle portion of the lower surface of the first base film 50e along the longitudinal direction of the first base film 50e, the middle portion being transversely confined by the right portion and the left portion of the lower surface of the first base film 50e; whereby lower surface of each of the third sticky linings 89b,89c,89d,89e, . . . is additionally in tight contact with a portion of the upper surface of the carrier tape so that when the cover tape is peeled off the carrier tape, the lower surface of each of the first sticky lining 87c, the second sticky lining 88c, and each of the third sticky linings 89b,89c,89d,89e, . . . , and the upper surface of the carrier tape is separated from each other along the longitudinal direction of the carrier tape.

Finally disclosed in FIG. 82 is a cross-sectional embodiment of the cover tape of FIG. 81, further consisting of a linear upper base-film coating 62b formed of one selected from a group consisting of: (1) anti-static material formed of at least one selected from a group consisting of carbon, metal, metal oxide, positive ion, negative ion, non-ion, and conductor inclusive of organic polymer; (2) coloring agent; and (3) release agent, and layered on upper surface of the first base film 50e in the longitudinal direction of the first base film 50e.

Having described a cross-sectional embodiment to each of the various carrier tapes in accordance with eleven versions of the present invention, wherein each of the first and second linings formed of sticky material, or non-sticky material is laminated longitudinally on the upper surface of either said first base film, second base film disposed uppermost or upper base-film coating made on the upper surface of the second base film disposed uppermost of the corresponding cover tapes, and in accordance with third through eleventh versions of the present invention, wherein each of either the first and second linings, or the first, second, and at least one third linings formed of sticky material, or non-sticky material is laminated longitudinally on the lower surface of either said first base film or lower base-film coating made on the lower surface of the first base film of the corresponding cover tapes, it is believed to be obvious that other modifications and variations will be suggested to those skilled in the art in the light of the above teachings. It is therefore to be understood that changes may be made in the particular cross-sectional embodiment of the linings in the transverse direction of the base film of the carrier tape in compliance with the present invention described which is within the full intended scope of the invention as defined by appended claims.

What is claimed is:

1. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear first lining comprising (1) a first film formed of flexible solid material and having a transversely elongated square cross section thereof along a longitudinal direction of the first film, and (2) a first sticky lining formed of sticky material and layered on lower surface of the first film, the first lining being stuck to the first base film such that a left portion of lower surface of the first sticky lining is in tight contact with a right portion of upper surface of the first base film along the longitudinal direction of the first base film; and
(c) a linear second lining comprising (1) a second film formed of flexible solid material and having a transversely elongated square cross section thereof along a longitudinal direction of the second film, and (2) a second sticky lining formed of sticky material and layered on lower surface of the second film, the second lining being stuck to the first base film such that a right portion of lower surface of the second sticky lining is in tight contact with a left portion of the upper surface of the first base film along the longitudinal direction of the first base film;
whereby when the cover tape is overlaid and born down hard on upper surface of the carrier tape wherein parts are captured, each of a right portion of the lower surface of the first sticky lining and a left portion of the lower surface of the second sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first sticky lining and the left portion of the lower surface of the second sticky lining, and the upper surface of the carrier tape separated from each other along the longitudinal direction of the carrier tape.

2. The cover tape in compliance with claim 1, wherein the cover tape further comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film.

3. The cover tape in compliance with claim 1, wherein the cover tape further comprises:
at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

4. The cover tape in compliance with claim 3, wherein the cover tape further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the lowermost second base film in the longitudinal direction of the first base film.

5. The cover tape in compliance with any one of claims 1, 2, 3 and 4, wherein the cover tape further comprises:
(a) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film; and
(b) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second film in the longitudinal direction of the second film.

6. The cover tape in compliance with claim 1, wherein the cover tape further comprises:
(a) at least one linear first upside film, each of the first upside films being formed of flexible solid material and having a transversely elongated square cross section thereof along a longitudinal direction of the first upside film, each of the first upside films being adhered to one another in such a way that lower surface of the first upside film disposed lowermost is in tight contact with upper surface of the first film in the longitudinal direction of the first film such that each of the first film and each of the first upside films stays together unless external force is applied thereto; and
(b) at least one linear second upside film, each of the second upside films being formed of flexible solid material and having a transversely elongated square cross section thereof along a longitudinal direction of the second upside film, each of the second upside films being adhered to one another in such a way that lower surface of the second upside film disposed lowermost is in tight contact with upper surface of the second film in the longitudinal direction of the second film such that each of the second film and each of the second upside films stays together unless external force is applied thereto.

7. The cover tape in compliance with claim 6, wherein the cover tape further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film.

8. The cover tape in compliance with any one of claims 6 and 7, wherein the cover tape further more comprises:
at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

9. The cover tape in compliance with claim 8, wherein the cover tape still further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the second base film disposed lowermost in the longitudinal direction of the first base film.

10. The cover tape in compliance with any one of claims 6, 7, 8 and 9, wherein the cover tape further more comprises:
(a) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first upside film disposed uppermost in the longitudinal direction of the first film; and
(b) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second upside film disposed uppermost in the longitudinal direction of the second film.

11. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in the longitudinal direction of the first base film;
(c) a linear lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film;
(d) a linear first lining comprising (1) a first film formed of flexible solid material and having a transversely elongated square cross section thereof along a longitudinal direction of the first film, and (2) a first sticky lining formed of sticky material and layered on lower surface of the first film, the first lining being stuck to the upper base-film coating such that a left portion of lower surface of the first sticky lining is in tight contact with a right portion of upper surface of the upper base-film coating along the longitudinal direction of the first base film;
(e) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film;
(f) a linear second lining comprising (1) a second film formed of flexible solid material and having a transversely elongated square cross section thereof along the longitudinal direction of the second film, and (2) a second sticky lining formed of sticky material and layered on lower surface of the second film, the second lining being stuck to the upper base-film coating such that a right portion of lower surface of the second sticky lining is in tight contact with a left portion of the upper surface of the upper base-film coating along the longitudinal direction of the first base film; and
(g) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on the upper surface of the second film in the longitudinal direction of the second film;
whereby when the cover tape is overlaid and born down hard on upper surface of the carrier tape wherein parts are captured, each of a right portion of the lower surface of the first sticky lining and a left portion of the lower surface of the second sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first sticky lining and the left portion of the lower surface of the second sticky lining, and the upper surface of the carrier tape separated from each other along the longitudinal direction of the carrier tape.

12. A cover tape to be overlaid on a carrier tape for carrying parts therewith, the cover tape comprising:
(a) a linear first base film, cross section of the first base film being of a transversely elongated square along a longitudinal direction of the first base film;
(b) a linear first lining comprising (1) a first film formed of flexible solid material and having a transversely elongated square cross section thereof along a longitudinal direction of the first film, and (2) a first non-sticky lining formed of non-sticky material and layered on lower surface of the first film, the first lining being heat-staked to the first base film such that a left portion of lower surface of the first non-sticky lining is in tight contact with a right portion of upper surface of the first base film along the longitudinal direction of the first base film; and
(c) a linear second lining comprising (1) a second film formed of flexible solid material and having a transversely elongated square cross section thereof along a longitudinal direction of the second film, and (2) a second non-sticky lining formed of non-sticky material and layered on lower surface of the second film, the second lining being heat-staked to the first base film such that a right portion of lower surface of the second non-sticky lining is in tight contact with a left portion of the upper surface of the first base film along the longitudinal direction of the first base film;
whereby when the cover tape is overlaid and heat-staked on upper surface of the carrier tape wherein parts are captured, each of a right portion of the lower surface of the first non-sticky lining and a left portion of the lower surface of the second non-sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first non-sticky lining and the left portion of the lower surface of the second non-sticky lining, and the upper surface of the carrier tape separated from each other along the longitudinal direction of the carrier tape.

13. The cover tape in compliance with claim 12, wherein the cover tape further comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film in the longitudinal direction of the first base film.

14. The cover tape in compliance with claim 12, wherein the cover tape further comprises:
at least one linear second base film, each of the second base films being formed of a flexible material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

15. The cover tape in compliance with claim 14, wherein the cover tape further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the second base film disposed lowermost in the longitudinal direction of the first base film.

16. The cover tape in compliance with any one of claims 12, 13, 14, and 15, wherein the cover tape further comprises:
(a) a first-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first film in the longitudinal direction of the first film; and
(b) a second-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second film in the longitudinal direction of the second film.

17. The cover tape in compliance with claim 12, wherein the cover tape further comprises:
(a) at least one linear first upside film, each of the first upside films being formed of flexible solid material and having a transversely elongated square cross section thereof along a longitudinal direction of the first upside film, each of the first upside films being adhered to one another in such a way that lower surface of the first upside film disposed lowermost is in tight contact with upper surface of the first film in the longitudinal direction of the first film such that each of the first film and each of the first upside films stays together unless external force is applied thereto; and
(b) at least one linear second upside film, each of the second upside films being formed of flexible solid material and having a transversely elongated square cross section thereof along a longitudinal direction of the second upside film, each of the second upside films being adhered to one another in such a way that lower surface of the second upside film disposed lowermost is in tight contact with upper surface of the second film in the longitudinal direction of the second film such that each of the second film and each of the second upside films stays together unless external force is applied thereto.

18. The cover tape in compliance with claim 17, wherein the cover tape further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film in the longitudinal direction of the first base film.

19. The cover tape in compliance with claim 17, wherein the cover tape further more comprises:
at least one linear second base film, each of the second base films being formed of flexible solid material and having a transversely elongated square cross section thereof along a longitudinal direction of the second base film, each of the second base films being adhered to one another in such a way that upper surface of the second base film disposed uppermost is in tight contact with lower surface of the first base film in the longitudinal direction of the cover tape such that each of the first base film and each of the second base films stays together unless external force is applied thereto.

20. The cover tape in compliance with claim 19, wherein the cover tape still further more comprises:
a lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the second base film disposed lowermost in the longitudinal direction of the first base film.

21. The cover tape in compliance with any one of claims 17, 18, 19 and 20, wherein the cover tape further more comprises:
(a) a first-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first upside film disposed uppermost in the longitudinal direction of the first base film; and
(b) a second-film lining formed of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second upside film disposed uppermost in the longitudinal direction of the first base film.

22. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in the longitudinal direction of the first base film;
(c) a linear lower base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on lower surface of the first base film in the longitudinal direction of the first base film;
(d) a linear first lining comprising (1) a first film formed of flexible solid material and having a transversely elongated square cross section thereof along a longitudinal direction of the first film, and (2) a first non-sticky lining formed of non-sticky material and layered on lower surface of the first film, the first lining being stuck to the upper base-film coating such that a left portion of lower surface of the first non-sticky lining is in tight contact with a right portion of upper surface of the upper base-film coating along the longitudinal direction of the first base film;
(e) a first-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first film in the longitudinal direction of the first film;
(f) a linear second lining comprising (1) a second film formed of flexible solid material and having a transversely elongated square cross section thereof along the longitudinal direction of the second film, and (2) a second non-sticky lining formed of non-sticky material and layered on lower surface of the second film, the second lining being stuck to the upper base-film coating such that a right portion of lower surface of the second non-sticky lining is in tight contact with a left portion of the upper surface of the upper base-film coating along the longitudinal direction of the first base film; and
(g) a second-film lining formed of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on the upper surface of the second film in the longitudinal direction of the second film;
whereby when the cover tape is overlaid and heat-staked on upper surface of the carrier tape wherein parts are captured, each of a right portion of the lower surface of the first non-sticky lining and a left portion of the lower surface of the second non-sticky lining is in tight contact with a portion of upper surface of the carrier tape along a longitudinal direction of the carrier tape so that each of the parts captured in between the carrier tape and the cover tape can be carried over to a place intended therefor to be ready to be taken out as the cover tape is peeled off the carrier tape with each of the right portion of the lower surface of the first non-sticky lining and the left portion of the lower surface of the second non-sticky lining, and the upper surface of the carrier tape separated from each other along the longitudinal direction of the carrier tape.

23. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear first lining comprising (1) a first film formed of flexible solid material and having a transversely elongated square cross section thereof along a longitudinal direction of the first film, (2) a first sticky lower lining formed of sticky material and layered on lower surface of the first film, and (3) a first sticky upper lining formed of sticky material and layered on upper surface of the first film, upper surface of the first sticky upper lining being stuck to a right portion of lower surface of the first base film along the longitudinal direction of the first film; and
(c) a linear second lining comprising (1) a second film formed of flexible solid material and having a transversely elongated square cross section thereof along a longitudinal direction of the second film, (2) a second sticky lower lining formed of sticky material and layered on lower surface of the second film, and (3) a second sticky upper lining formed of sticky material and layered on upper surface of the second film, upper surface of the second sticky upper lining being stuck to a left portion of the lower surface of the first base film along the longitudinal direction of the second film;
whereby when the cover tape is overlaid and born down hard on upper surface of the carrier tape wherein parts are captured, lower surface of each of the first sticky lining and second sticky lower lining is in tight contact with a portion of upper surface of the carrier tape along a longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

24. The cover tape in compliance with claim 23, wherein the cover tape further comprises:
at least one linear third lining, each of the third linings comprising (1) a third film formed of flexible solid material and having a transversely elongated square cross section thereof along a longitudinal direction of the third film, (2) a third sticky lower lining formed of sticky material and layered on lower surface of the third film, and (3) a third sticky upper lining formed of sticky material and layered on upper surface of the third film, upper surface of the third sticky upper lining being stuck to a portion of a middle portion of the lower surface of the first base film along the longitudinal direction of the first base film, the middle portion being transversely confined by the left and right portion of the lower surface of the first base film along the longitudinal direction of the first base film;
whereby lower surface of each of the third sticky lower linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

25. The cover tape in compliance with any one of claims 23 and 24, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

26. The cover tape in compliance with any one of claims 23 and 24, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

27. The cover tape in compliance with claim 26, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

28. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film;
(c) a linear first lining comprising (1) a first film formed of flexible solid material and having a transversely elongated square cross section thereof along a longitudinal direction of the first film, (2) a first sticky lower lining formed of sticky material and layered on lower surface of the first film, and (3) a first sticky upper lining formed of sticky material and layered on upper surface of the first film, upper surface of the first sticky upper lining being stuck to a right portion of lower surface of the lower base-film coating along the longitudinal direction of the first base film; and
(d) a linear second lining comprising (1) a second film formed of flexible solid material and having a transversely elongated square cross section thereof along a longitudinal direction of the second film, (2) a second sticky lower lining formed of sticky material and layered on lower surface of the second film, and (3) a second sticky upper lining formed of sticky material and layered on upper surface of the second film, upper surface of the second sticky upper lining being stuck to a left portion of the lower surface of the lower base-film coating along the longitudinal direction of the first base film;
whereby when the cover tape is overlaid and born down hard on upper surface of the carrier tape wherein parts are captured, lower surface of each of the first and second sticky lower lining is in tight contact with a portion of upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lower lining, and the upper surface of the carrier tape separated from each other along the longitudinal direction of the carrier tape.

29. The cover tape in compliance with claim 28, wherein the cover tape further comprises:
at least one linear third lining, each of the third linings comprising (1) a third film formed of flexible solid material and having a transversely elongated square cross section thereof along a longitudinal direction of the third film, (2) a third sticky lower lining formed of sticky material and layered on upper surface of the third film, and (3) a third sticky upper lining formed of sticky material and layered on lower surface of the third film, upper surface of the third sticky upper lining being stuck to a portion of a middle portion of the lower surface of the lower base-film coating along the longitudinal direction of the first base film, the middle portion being transversely confined by the right portion and the left portion of the lower surface of the lower base-film coating along the longitudinal direction of the first base film;
whereby lower surface of each of the third sticky lower linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

30. The cover tape in compliance with any one of claims 28 and 29, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

31. The cover tape in compliance with any one of claims 28 and 29, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the lower base-film coating in the longitudinal direction of the first base film such that each of the first base film and each of the second base films stays together unless external force is applied thereto.

32. The cover tape in compliance with claim 31, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

33. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film;
(c) a linear first sticky lining formed of sticky material and laminated on a right portion of lower surface of the lower base-film coating along the longitudinal direction of the first base film; and
(d) a linear second sticky lining formed of sticky material and laminated on a left portion of the lower surface of the lower base-film coating along the longitudinal direction of the first base film, the right portion and the left portion of the lower surface of the lower base-film coating transversely confining a middle portion of the lower surface of the lower base-film coating along the longitudinal direction of the base film;
whereby when the cover tape is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

34. The cover tape in compliance with claim 33, wherein the cover tape further comprises:
at least one linear third sticky lining, each of the third sticky linings being formed of sticky material and laminated on a portion of the middle portion of the lower surface of the lower base-film coating along the longitudinal direction of the first base film;
whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

35. The cover tape in compliance with any one of claims 33 and 34, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

36. The cover tape in compliance with any one of claims 33 and 34, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

37. The cover tape in compliance with claim 36, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

38. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film;
(c) a linear first non-sticky lining formed of non-sticky material and layered on a right portion of lower surface of the lower base-film coating along the longitudinal direction of the first base film; and
(d) a linear second non-sticky lining formed of non-sticky material and layered on a left portion of the lower surface of the lower base-film coating along the longitudinal direction of the first base film, the right portion and the left portion of the lower surface of the lower base-film coating transversely confining a middle portion of the lower surface of the lower base-film coating along the longitudinal direction of the base film;
whereby when the cover tape is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

39. The cover tape in compliance with claim 38, wherein the cover tape further comprises:
at least one linear third non-sticky lining, each of the third non-sticky linings being formed of non-sticky material and layered on a portion of the middle portion of the lower surface of the lower base-film coating along the longitudinal direction of the first base film;
whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

40. The cover tape in compliance with any one of claims 38 and 39, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in a longitudinal direction of the first base film.

41. The cover tape in compliance with any one of claims 38 and 39, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

42. The cover tape in compliance with claim 41, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second base film disposed uppermost in the longitudinal direction of the first base film.

43. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a first combinational lining comprising (1) a first non-sticky lining formed of non-sticky material, and (2) a first sticky lining formed of sticky material and layered on lower surface of the first non-sticky lining along a longitudinal direction of the first non-sticky lining, the first non-sticky lining being laminated on a right portion of lower surface of the first base film along the longitudinal direction of the first base film; and
(c) a second combinational lining comprising (1) a second non-sticky lining formed of non-sticky material, and (2) a second sticky lining formed of sticky material and layered on lower surface of the second non-sticky lining along a longitudinal direction of the second non-sticky lining, the second non-sticky lining being laminated on a left portion of lower surface of the first base film along the longitudinal direction of the first base film;
whereby when the cover tape is overlaid and born down hard on upper surface of the carrier tape wherein parts are captured, lower surface of each of the first combinational lining and the second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining and the second combinational lining, and the upper surface of the carrier tape separated from each other along the longitudinal direction of the carrier tape.

44. The cover tape in compliance with claim 43, wherein the cover tape further comprises:
at least one third combinational lining, each of the third combinational linings comprising (1) a third non-sticky lining formed of non-sticky material, and (2) a third sticky lining formed of sticky material and layered on lower surface of the third non-sticky lining along the longitudinal direction of the third non-sticky lining, the third non-sticky lining being laminated on a portion of a middle portion of the lower surface of the first base film along the longitudinal direction of the first base film, the middle portion being transversely confined by the left portion and the right portion of the lower surface of the first base film;
whereby lower surface of each of the third combinational linings is additionally in tight contact with a portion of the upper surface of the carrier tape so that when the cover tape is peeled off the carrier tape, the lower surface of each of the first combinational lining, the second combinational lining, and each of the third combinational linings, and the upper surface of the carrier tape is separated from each other along the longitudinal direction of the carrier tape.

45. The cover tape in compliance with any one of claims 43 and 44, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

46. The cover tape in compliance with any one of claims 43 and 44, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

47. The cover tape in compliance with claim 46, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

48. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered -on lower surface of the first base film along the longitudinal direction of the first base film;
(c) a first combinational lining comprising (1) a first non-sticky lining formed of non-sticky material, and (2) a first sticky lining formed of sticky material and layered on lower surface of the first non-sticky lining along a longitudinal direction of the first non-sticky lining, the first non-sticky lining being laminated on a right portion of lower surface of the lower base-film coating along the longitudinal direction of the first base film; and
(d) a second combinational lining comprising (1) a second non-sticky lining formed of non-sticky material, and (2) a second sticky lining formed of sticky material and layered on lower surface of the second non-sticky lining along a longitudinal direction of the second non-sticky lining, the second non-sticky lining being laminated on left portion of lower surface of the lower base-film coating along the longitudinal direction of the first base film;
whereby when the cover tape is overlaid and born down hard on upper surface of the carrier tape wherein parts are captured, lower surface of each of the first and second combinational lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first combinational lining and the second combinational lining, and the upper surface of the carrier tape separated from each other along the longitudinal direction of the carrier tape.

49. The cover tape in compliance with claim 48, wherein the cover tape further comprises:
at least one third combinational lining, each of the third combinational linings comprising (1) a third non-sticky lining formed of non-sticky material, and (2) a third sticky lining formed of sticky material and layered on lower surface of the third non-sticky lining along a longitudinal direction of the third non-sticky lining, the third non-sticky lining being laminated on a portion of a middle portion of the lower surface of the lower base-film coating along the longitudinal direction of the first base film, the middle portion being transversely confined by the left portion and the right portion of the lower surface of the lower base-film coating;
whereby lower surface of each of the third combinational linings is additionally in tight contact with a portion of the upper surface of the carrier tape so that when the cover tape is peeled off the carrier tape, the lower surface of each of the first combinational lining, the second combinational lining, and each of the third combinational linings, and the upper surface of the carrier tape is separated from each other along the longitudinal direction of the carrier tape.

50. The cover tape in compliance with any one of claims 48 and 49, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.

51. The cover tape in compliance with any one of claims 48 and 49, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

52. The cover tape in compliance with claim 51, wherein the cover tape further more comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the second base film disposed uppermost in the longitudinal direction of the first base film.

53. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear first non-sticky lining formed of non-sticky material and layered on a right portion of lower surface of the first base film along the longitudinal direction of the first base film; and
(c) a linear second non-sticky lining formed of non-sticky material and layered on a left portion of lower surface of the first base film along the longitudinal direction of the first base film;
whereby when the cover tape is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

54. The cover tape in compliance with claim 53, wherein the cover tape further comprises:
at least one linear third non-sticky lining, each of the third non-sticky linings being formed of non-sticky material and layered on a portion of a middle portion of the lower surface of the first base film along the longitudinal direction of the first base film, the middle portion being transversely confined by the right portion and left portion of the lower surface of the first base film;
whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

55. The cover tape in compliance with any one of claims 53 and 54, wherein the cover tape further comprises:
at least one linear second base film, cross section of each of the second base films being of a transversely elongated square along a longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto.

56. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film;
(c) a linear first non-sticky lining formed of non-sticky material and layered on a right portion of lower surface of the lower base-film coating along the longitudinal direction of the first base film;
(d) a linear second non-sticky lining formed of non-sticky material and layered on a left portion of the lower surface of the lower base-film coating along the longitudinal direction of the first base film; and
(e) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the first base film in the longitudinal direction of the first base film;
whereby when the cover tape is overlaid and heat-staked on upper surface of the carrier tape wherein parts are captured, lower surface of each of the first non-sticky lining and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

57. The cover tape in compliance with claim 56, wherein the cover tape further comprises:
at least one linear third non-sticky lining formed of non-sticky material and layered on a middle portion of the lower surface of the lower base-film coating along the longitudinal direction of the first base film, the middle portion being transversely confined by the right portion and the left portion of the lower surface of the lower base-film coating along the longitudinal direction of the first base film;
whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

58. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear lower base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on lower surface of the first base film along the longitudinal direction of the first base film;
(c) a linear second base film formed of flexible solid material, cross section of the first base film being of a transversely elongated square along a longitudinal direction of the first base film, lower surface of the second base film being adhered to upper surface of the first base film;
(d) a linear first non-sticky lining formed of non-sticky material and layered on a right portion of lower surface of the lower base-film coating along the longitudinal direction of the first base film;
(e) a linear second non-sticky lining formed of non-sticky material and layered on a left portion of the lower surface of the lower base-film coating along the longitudinal direction of the first base film; and
(f) a linear upper base-film coating made of one selected from a group consisting of (1) anti-static material formed of at least one selected from a group consisting of carbon, metal, metal oxide, positive ion, negative ion, non-ion, and conductor inclusive of organic polymer, and (2) coloring agent, and layered on upper surface of the second base film in the longitudinal direction of the first base film;
whereby when the cover tape is overlaid and heat-staked on upper surface of the carrier tape wherein parts are captured, lower surface of each of the first and second non-sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first non-sticky lining and the second non-sticky lining, and the upper surface of the carrier tape separated from each other along the longitudinal direction of the carrier tape.

59. The cover tape in compliance with claim 58, wherein the cover tape further comprises:
at least one linear third non-sticky lining formed of non-sticky material and layered on a middle portion of the lower surface of the lower base-film coating along the longitudinal direction of the first base film, the middle portion being transversely confined by the right portion and the left portion of the lower surface of the lower base-film coating along the longitudinal direction of the first base film;
whereby lower surface of each of the third non-sticky linings is additionally in tight contact with a portion of the upper surface of the carrier tape so that when the cover tape is peeled off the carrier tape, the lower surface of each of the first non-sticky lining, the second non-sticky lining, and each of the third non-sticky linings, and the upper surface of the carrier tape is separated from each other along the longitudinal direction of the carrier tape.

60. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film;
(c) a linear first sticky lining formed of sticky material and laminated on a right portion of lower surface of the first base film along the longitudinal direction of the first base film; and
(d) a linear second sticky lining formed of sticky material and laminated on a left portion of lower surface of the first base film along the longitudinal direction of the first base film;
whereby when the cover tape is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

61. The cover tape in compliance with claim 60, wherein the cover tape further comprises:
at least one linear third sticky lining, each of the third sticky linings being formed of sticky material and laminated on a portion of a middle portion of the lower surface of the first base film along the longitudinal direction of the first base film, the middle portion being transversely confined by the right portion and the left portion of the lower surface of the first base film;
whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

62. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) a linear first sticky lining formed of sticky material and laminated on a right portion of lower surface of the first base film along the longitudinal direction of the first base film;
(c) a linear second sticky lining formed of sticky material and laminated on a left portion of the lower surface of the first base film along the longitudinal direction of the first base film; and
(d) at least one linear third sticky lining, each of the third sticky linings being formed of sticky material and laminated on a portion of a middle portion of the lower surface of the first base film along the longitudinal direction of the first base film, the middle portion being transversely confined by the right portion and the left portion of the lower surface of the first base film;
whereby when the cover tape is overlaid and born down hard on upper surface of the carrier tape wherein parts are captured, lower surface of each of the first sticky lining, the second sticky lining, and each of the third sticky linings is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining, the second sticky lining, and each of the third sticky linings, and the upper surface of the carrier tape separated from each other along the longitudinal direction of the carrier tape.

63. A cover tape to be overlaid on a carrier tape for carrying parts therewith, the cover tape comprising:
(a) a linear first base film made of flexible solid material, cross section of the first base film being of a transversely elongated square along a longitudinal direction of the first base film;
(b) at least one linear second base film, each of the second base films being formed of flexible solid material, cross section of each of the second base films being of a transversely elongated square along the longitudinal direction of the second base film, each of the second base films being adhered to one another in such a way that lower surface of the second base film disposed lowermost is in tight contact with upper surface of the first base film in the longitudinal direction of the first base film such that each of the first base film and each of the second base films stays together unless external force is applied thereto;
(c) a linear first sticky lining formed of sticky material and laminated on a right portion of lower surface of the first base film along the longitudinal direction of the first base film; and
(d) a linear second sticky lining formed of sticky material and laminated on a left portion of the lower surface of the first base film along the longitudinal direction of the first base film;
whereby when the cover tape is overlaid and born down hard on upper surface of the carrier tape wherein parts are captured, lower surface of each of the first and second sticky lining is in tight contact with a portion of the upper surface of the carrier tape along the longitudinal direction of the carrier tape so that each of the parts captured in between the cover tape and the carrier tape can be carried over to a place intended therefor to be ready to be taken out as the cover tape is peeled off the carrier tape with lower surface of each of the first sticky lining and the second sticky lining, and the upper surface of the carrier tape separated from each other along the longitudinal direction of the carrier tape.

64. The cover tape in compliance with claim 63, wherein the cover tape further comprises:
at least one linear third sticky lining, each of the third sticky linings being formed of sticky material and laminated on a portion of a middle portion of the lower surface of the first base film along the longitudinal direction of the first base film, the middle portion being transversely confined by the right portion and the left portion of the lower surface of the first base film;
whereby lower surface of each of the third sticky linings is additionally in tight contact with a portion of the upper surface of the carrier tape so that when the cover tape is peeled off the carrier tape, the lower surface of each of the first sticky lining, the second sticky lining, and each of the third sticky linings, and the upper surface of the carrier tape is separated from each other along the longitudinal direction of the carrier tape.

65. The cover tape in compliance with any one of claims 63 and 64, wherein the cover tape further comprises:
a linear upper base-film coating made of one selected from a group consisting of (1) anti-static material formed of at least one selected from a group consisting of carbon, metal, metal oxide, positive ion, negative ion, non-ion, and conductor inclusive of organic polymer, (2) coloring agent, and (3) release agent, and layered on upper surface of the first base film in the longitudinal direction of the first base film.
